(19) United States
(12) Patent Application Publication
(10) Pub. No.: US 2011/0039165 A1
(43) Pub. Date: Feb. 17, 2011

(54) FUEL CELL AND METHOD FOR MANUFACTURING THE SAME, ENZYME-IMMOBILIZED ELECTRODE AND METHOD FOR MANUFACTURING THE SAME, AND ELECTRONIC APPARATUS

(75) Inventors: Taiki Sugiyama, Kanagawa (JP); Hideki Sakai, Kanagawa (JP); Yuichi Tokita, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/922,332

(22) PCT Filed: Mar. 10, 2009
(86) PCT No.: PCT/JP2009/054647

§ 371 Date: Sep. 13, 2010

(30) Foreign Application Priority Data
Mar. 12, 2008 (JP) 2008-06233
Jan. 15, 2009 (JP) 2009-006973

(51) Int. Cl. H01M 8/16; H01M 4/88

(52) U.S. Cl. 429/401; 429/535

(57) ABSTRACT

There is provided a fuel cell whose current density and maintenance ratio can be improved when at least glucose dehydrogenase and diaphorase are immobilized on an anode using an immobilizing material composed of poly-L-lysine and glutaraldehyde. The fuel cell has a structure in which a cathode 2 and an anode 1 face each other with an electrolyte layer 3 therebetween, the anode 1 being obtained by immobilizing at least glucose dehydrogenase and diaphorase on an electrode using an immobilizing material composed of poly-L-lysine and glutaraldehyde, wherein the mass ratio of the poly-L-lysine to the glutaraldehyde in an immobilizing material is 5:1 to 80:1, the mass ratio of the glucose dehydrogenase to the diaphorase is 1:3 to 200:1, and the average molecular weight of the poly-L-lysine is 21500 or more.

### TECHNICAL FIELD

The present invention relates to a fuel cell and a method for manufacturing the same, an enzyme-immobilized electrode and a method for manufacturing the same, and an electronic apparatus. Specifically, the present invention is suitably applied to a fuel cell in which at least glucose dehydrogenase and diaphorase are immobilized on an anode using an immobilizing material composed of poly-L-lysine and glutaraldehyde, and a method for manufacturing the fuel cell.

Furthermore, the present invention relates to an enzyme-immobilized electrode suitably used for the fuel cell and a method for manufacturing the enzyme-immobilized electrode, and to an electronic apparatus.

### BACKGROUND ART

Fuel cells have a structure in which the cathode (oxidizer electrode) and the anode (fuel electrode) face each other with an electrolyte (proton conductor) therebetween. In conventional fuel cells, the fuel (hydrogen) supplied to the anode is oxidized and separated into electrons and protons (H⁺); the electrons are delivered to the anode; and H⁺ moves through the electrolyte to the cathode. At the cathode, the H⁺ reacts with oxygen supplied from the outside and electrons transmitted from the anode through an external circuit to generate H₂O.

As described above, fuel cells are highly efficient power-generating devices that convert the chemical energy possessed by a fuel directly into electrical energy. In other words, fuel cells are capable of extracting the chemical energy possessed by fossil energy, such as natural gas, petroleum, or coal, as electrical energy, regardless of the place of use or time of use, with high conversion efficiency. Therefore, conventionally, research and development has been actively carried out on fuel cells for application to large-scale power generation, etc. For example, it has been proved that fuel cells installed in space shuttles are capable of supplying electrical power as well as water for the crew and that fuel cells are clean power-generating devices.

Furthermore, in recent years, fuel cells, such as solid polymer fuel cells, that have a relatively low operating temperature range from room temperature to about 90° C., have been developed and have been receiving attention. Therefore, not only application to large-scale power generation, but also application to small systems such as power sources for running automobiles and portable power sources for personal computers and mobile devices has been sought after.

As described above, fuel cells are believed to have a wide range of applications from large-scale power generation to small-scale power generation, and have been receiving much attention as highly efficient power-generating devices. However, in fuel cells, natural gas, petroleum, coal, or the like is normally converted into hydrogen gas using a reformer, the hydrogen gas being used as a fuel, which poses a problem in that limited resources are consumed. In addition, there are problems in that fuel cells need to be heated to high temperature and require a catalyst composed of an expensive noble metal such as platinum (Pt). Furthermore, even in the case where hydrogen gas or methanol is directly used as a fuel, the handling thereof requires care.

Under these circumstances, focusing on the fact that the biological metabolism that takes place in living things is a highly efficient energy conversion mechanism, the application of biological metabolism to a fuel cell has been proposed. Herein, biological metabolism includes respiration, photosynthesis, and the like taking place in microorganism cells. Biological metabolism has a characteristic in that its power generation efficiency is very high and the reaction proceeds under mild conditions such as at about room temperature.

For example, respiration is a mechanism with which nutrients such as saccharides, fats, and proteins are taken into microorganisms or cells, and the chemical energy thereof is converted into electrical energy through the following steps. In other words, carbon dioxide (CO₂) is generated from the taken nutrients through a glycolytic pathway and a tricarboxylic acid (TCA) cycle including many enzyme reaction steps. In the process of generating carbon dioxide, the chemical energy is converted into oxidation-reduction energy, i.e., electrical energy by reducing nicotinamide adenine dinucleotide (NAD⁺) to reduced nicotinamide adenine dinucleotide (NADH). Furthermore, in an electron transport system, the electrical energy of the NADH is directly converted into the electrical energy of a proton gradient, and also oxygen is reduced to generate water. The electrical energy obtained here generates, through an adenosine triphosphate (ATP) synthase, ATP from adenosine diphosphate (ADP). The ATP is used for reactions required for the growth of microorganisms and cells. Such energy conversion takes place in cytosol and mitochondria.

Furthermore, photosynthesis is a mechanism with which, in the process of taking in light energy and converting light energy into electrical energy by reducing nicotinamide adenine dinucleotide phosphate (NADP⁺) to reduced nicotinamide adenine dinucleotide phosphate (NADPH) through an electron transport system, water is oxidized to generate oxygen. The electrical energy is used for a carbon immobilization reaction in which CO₂ is taken in and for synthesis of carbohydrates.

As a technology in which the biological metabolism described above is used for a fuel cell, a microbial cell has been reported, in which electrical energy generated in microorganisms is taken out of the microorganisms through an electron mediator and the electrons are delivered to an electrode to obtain an electric current (for example, refer to Japanese Unexamined Patent Application Publication No. 2000-133297).

However, microorganisms and cells include many unnecessary reactions other than target reactions that convert chemical energy into electrical energy. Thus, in the above-described method, chemical energy is consumed in undesired reactions, and sufficient energy conversion efficiency is not obtained.

Under these circumstances, fuel cells (biofuel cells) in which only a desired reaction is carried out using an enzyme have been proposed (e.g., refer to Japanese Unexamined Patent Application Publication No. 2003-282124, Japanese Unexamined Patent Application Publication No. 2004-71559, Japanese Unexamined Patent Application Publication No. 2005-13210, Japanese Unexamined Patent Application Publication No. 2005-310613, Japanese Unexamined Patent Application Publication No. 2006-24555, Japanese Unexamined Patent Application Publication No. 2006-49215, Japanese Unexamined Patent Application Publication No. 2006-93090, Japanese Unexamined Patent Application Publication No. 2006-127957, Japanese Unexamined Patent Application Publication No. 2006-156354, Japanese Unexamined Patent Application Publication No. 2007-12281, Japanese Unexamined Patent Application Publication No. 2007-35437, and Japanese Unexamined Patent Application Publication No. 2007-87627). In such biofuel cells, a fuel is decomposed by an enzyme and separated into protons and electrons. There have been developed biofuel cells that use, as a fuel, alcohols such as methanol and ethanol; monosaccharides such as glucose; or polysaccharides such as starch.

In such biofuel cells, it is known that the immobilization of an enzyme and an electron mediator on an electrode is extremely important, which significantly affects the output characteristics, life, and efficiency of biofuel cells. Conventionally, it is known that, at the anode of biofuel cells that use glucose as a fuel, glucose dehydrogenase, diaphorase, an electron mediator, and the like are immobilized on an electrode. On the other hand, an immobilizing material composed of poly-L-lysine and glutaraldehyde is known as an immobilizing material used for immobilizing an enzyme or the like (e.g., refer to Japanese Unexamined Patent Application Publication No. 2005-13210).

In the anode of the above-described biofuel cells, there has been no detailed consideration for the mass ratio between poly-L-lysine and glutaraldehyde when at least glucose dehydrogenase and diaphorase are immobilized on an electrode using the above-described immobilizing material. Similarly, there has been no detailed consideration for the mass ratio between glucose dehydrogenase and diaphorase. Furthermore, there has been no detailed consideration for the molecular weight of poly-L-lysine.

However, the research conducted by the inventors of the present invention has revealed that such mass ratios and molecular weight significantly affect the current density and its maintenance ratio.

Thus, an object of the present invention is to provide a fuel cell whose current density and maintenance ratio can be improved when at least glucose dehydrogenase and diaphorase are immobilized on the anode using the immobilizing material, and a method for manufacturing the fuel cell.

Another object of the present invention is to provide an enzyme-immobilized electrode that is suitably applied to the anode of a fuel cell obtained by immobilizing at least glucose dehydrogenase and diaphorase on the anode using the immobilizing material, and a method for manufacturing the enzyme-immobilized electrode.

Still another object of the present invention is to provide an electronic apparatus that uses the above-described excellent fuel cell.

### DISCLOSURE OF INVENTION

Although specifically described below, the inventors of the present invention have conducted extensive research on the mass ratio of poly-L-lysine to glutaraldehyde when at least glucose dehydrogenase and diaphorase are immobilized on the anode using the above-described immobilizing material. Furthermore, the inventors also have conducted extensive research on the average molecular weight of poly-L-lysine and the mass ratio of glucose dehydrogenase to diaphorase. Consequently, the inventors have found that there are optimum ranges for these mass ratios and average molecular weight and have completed the present invention.

That is, to solve the above-described problems, the present invention provides:

a fuel cell having a structure in which a cathode and an anode face each other with a proton conductor therebetween,

wherein the anode is obtained by immobilizing at least glucose dehydrogenase and diaphorase on an electrode using an immobilizing material composed of poly-L-lysine and glutaraldehyde, and

the mass ratio of the poly-L-lysine to the glutaraldehyde is 5:1 to 80:1.

The present invention also provides:

a method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the mass ratio of the poly-L-lysine to the glutaraldehyde is set to 5:1 to 80:1.

In the present invention, glucose dehydrogenase (particularly, NAD⁺-dependent glucose dehydrogenase) is an oxidase that promotes the oxidation of glucose, which is a monosaccharide, to decompose glucose. Diaphorase is a coenzyme oxidase that converts the coenzyme reduced by the glucose dehydrogenase back into an oxidant. In addition to glucose dehydrogenase and diaphorase, an electron mediator is suitably immobilized on the anode, and a coenzyme is also optionally immobilized on the anode. For example, nicotinamide adenine dinucleotide (NAD⁺) is used as the coenzyme immobilized on the anode, and diaphorase is an oxidase of the coenzyme. In this case, through the action of diaphorase, electrons are generated when the coenzyme is converted back into an oxidant, and the electrons are transferred from the coenzyme oxidase to the electrode through the electron mediator.

Meanwhile, when an enzyme is immobilized on the cathode, the enzyme typically contains an oxygen reductase. Examples of the oxygen reductase that can be used include bilirubin oxidase, laccase, and ascorbate oxidase. Table 1 shows the details of some oxygen reductases (multicopper oxidase). In this case, in addition to the enzyme, an electron mediator is also desirably immobilized on the cathode. Examples of the electron mediator include potassium hexacyanoferrate, potassium ferricyanide, and potassium octacyanotungstate. The electron mediator is desirably immobilized at sufficiently high concentration, for example, 0.64×10⁻⁶ mol/mm² or more on average.

TABLE 1

| | | | Functions within the | | |
|---|---|---|---|---|---|
| Name | Another name | Origin | living body | Molecular weight | Remarks |
| plant laccase | polyphenol oxidase | plant | lignin formation, | 450 to 600 aa | pH ~5, maximum |
| | | | glycoprotein | | pH 8, myrothecium, |
| fungal laccase | as above | fungus | chromogenesis, lignin | as above | 50° C. |
| | | | decomposition, | | |
| | | | glycoprotein | | |
| Fet3p | ferroxidase | saccharomyces | iron metabolism, | 85 kDa | pH range 2 to 9 |
| | | cerevisiae | membrane protein, | | |
| | | | glycoprotein | | |
| hephaestin | as above | human | as above | 130 kDa | |
| ceruloplasmin | as above | as above | iron metabolism, | 130 to 135 kDa | optimum pH 6.5, |
| | | | glycoprotein | | KmO₂ = 10⁻² to 10⁻³ |
| CueO (YacK) | CuiD, CopA | E. coli, etc. | copper homeostasis | 500 aa | |
| PcoA | | E. coli | copper resistance | 565 aa | |
| CotA | spore coat protein | bacillus (spore | formation of spore, Mn | 65 kDa | 80° C. (2 to 4 hours) |
| | | forming bacteria) | (II) oxidation | | |
| | | gram-positive | | | |
| CumA | | pseudomonas | | | |
| | | gram-negative | | | |
| ascorbate oxidase | | plant (vegetable, | ascorbic acid metabolism, | 140 kDa | maximum 60° C., 30 |
| | | fruit) | glycoprotein | | minutes |

Any electron mediator may be basically used, and a compound having a quinone skeleton, particularly a compound having a naphthoquinone skeleton, is desirably used. Various naphthoquinone derivatives can be used as the compound having a naphthoquinone skeleton. Examples of the naphthoquinone derivatives include 2-amino-1,4-naphthoquinone (ANQ), 2-amino-3-methyl-1,4-naphthoquinone (AMNQ), 2-methyl-1,4-naphthoquinone (VK3), and 2-amino-3-carboxy-1,4-naphthoquinone (ACNQ). As for the compound having a quinone skeleton, for example, anthraquinone and derivatives thereof can also be used in addition to the compound having a naphthoquinone skeleton. The electron mediator may optionally contain one type or two or more types of other compounds serving as the electron mediator, in addition to the compound having a quinone skeleton. As for a solvent used when a compound having a quinone skeleton, particularly a compound having a naphthoquinone skeleton, is immobilized on the anode, acetone is desirably used. By using acetone as a solvent in this manner, the solubility of the compound having a quinone skeleton can be increased, and the compound having a quinone skeleton can be efficiently immobilized on the anode. The solvent may optionally contain one or two or more solvents other than acetone.

Various materials can be used as a material of the cathode or the anode. For example, carbon-based materials such as porous carbon, carbon pellets, carbon felt, and carbon paper are used.

As for the proton conductor, various substances can be used as long as they have no electron conductivity and conduct only protons, and are selected as needed.

Specifically, the following substances are exemplified as the proton conductor.

cellophane

perfluorocarbon sulfonic acid (PFS)-based resin film

copolymer film of trifluorostyrene derivatives

phosphoric acid-impregnated polybenzimidazole film

aromatic polyether ketone sulfonic acid film

PSSA-PVA (polystyrene sulfonic acid-polyvinyl alcohol copolymer)

PSSA-EVOH (polystyrene sulfonic acid-ethylene vinyl alcohol copolymer)

ion exchange resin having a fluorine-containing carbon sulfonic acid group (e.g., Nafion (trade name, DuPont, USA))

In the case where an electrolyte containing a buffer substance (buffer solution) is used as the proton conductor, it is desirable that a sufficient buffering action can be achieved even if an increase and decrease in the number of protons is caused in an electrode or an enzyme-immobilizing film due to the enzyme reaction using protons during the high-output operation. By achieving such a sufficient buffering action, a shift of pH from an optimum pH can be sufficiently reduced, and the capacity intrinsic to the enzyme can be satisfactorily exerted. To achieve this, it is effective to specify the concentration of the buffer substance contained in the electrolyte to 0.2 M or more and 2.5 M or less, preferably 0.2 M or more and 2 M or less, more preferably 0.4 M or more and 2 M or less, and further preferably 0.8 M or more and 1.2 M or less. In general, any buffer substance may be used as long as the substance has a pKₐ of 5 or more and 9 or less. Specific examples are as follows.

dihydrogen phosphate ion (H₂PO₄⁻)

2-amino-2-hydroxymethyl-1,3-propanediol (abbreviated as Tris)

2-(N-morpholino)ethanesulfonic acid (MES)

cacodylic acid

carbonic acid (H₂CO₃)

hydrogen citrate ion

N-(2-acetamide)iminodiacetic acid (ADA)

piperazine-N,N′-bis(2-ethanesulfonic acid) (PIPES)

N-(2-acetamido)-2-aminoethanesulfonic acid (ACES)

3-(N-morpholino)propanesulfonic acid (MOPS)

N-2-hydroxyethylpiperazine-N′-2-ethanesulfonic acid (HEPES)

N-2-hydroxyethylpiperazine-N′-3-propanesulfonic acid (HEPPS)

N-[tris(hydroxymethyl)methyl]glycine (abbreviated as tricine)

glycylglycine

N,N-bis(2-hydroxyethyl)glycine (abbreviated as bicine)

Examples of a substance that produces dihydrogen phosphate ions (H₂PO₄⁻) include sodium dihydrogen phosphate (NaH₂PO₄) and potassium dihydrogen phosphate (KH₂PO₄). A compound having an imidazole ring is also preferred as a buffer substance. Specific examples of the compound having an imidazole ring are as follows.

imidazole

triazole

pyridine derivative

bipyridine derivative

imidazole derivative

Specific examples of the imidazole derivative are as follows.

histidine

1-methylimidazole

2-methylimidazole

4-methylimidazole

2-ethylimidazole

ethyl imidazole-2-carboxylate

imidazole-2-carboxaldehyde

imidazole-4-carboxylic acid

imidazole-4,5-dicarboxylic acid

imidazol-1-yl-acetic acid

2-acetylbenzimidazole

1-acetylimidazole

N-acetylimidazole

2-aminobenzimidazole

N-(3-aminopropyl)imidazole

5-amino-2-(trifluoromethyl)benzimidazole

4-azabenzimidazole

4-aza-2-mercaptobenzimidazole

benzimidazole

1-benzylimidazole

1-butylimidazole

As for the buffer substance other than those described above, 2-aminoethanol, triethanolamine, TES (N-tris(hydroxymethyl)methyl-2-aminoethanesulfonic acid), BES (N,N-bis(2-hydroxyethyl)-2-aminoethanesulfonic acid), or the like may also be used.

In addition to the above-described buffer substances, for example, at least one acid selected from the group consisting of hydrochloric acid (HCl), acetic acid (CH₃COOH), phosphoric acid (H₃PO₄), and sulfuric acid (H₂SO₄) may be added as a neutralizer so that higher enzyme activity can be maintained. The pH of the electrolyte containing the buffer substance is desirably about 7, but may be at any value of 1 to 14 in general.

The entire structure of this fuel cell is selected according to need. For example, when the fuel cell has a coin-type or button-type structure, preferably, the fuel cell has a structure in which the cathode, the electrolyte, and the anode are accommodated inside a space formed between a cathode current collector having a structure through which an oxidizing agent can permeate and an anode current collector having a structure through which a fuel can permeate. Furthermore, in this case, typically, the edge of one of the cathode current collector and the anode current collector is caulked to the other of the cathode current collector and the anode current collector, with an insulating sealing member therebetween, whereby the space for accommodating the cathode, the electrolyte, and the anode is formed, but the structure is not limited to this. For example, the space may be formed by another processing method according to need. The cathode current collector and the anode current collector are electrically insulated from each other through the insulating sealing member. As the insulating sealing member, typically, a gasket composed of an elastic material such as silicone rubber is used, but the insulating sealing member is not limited to this. The planar shape of the cathode current collector and the anode current collector may be selected according to need, and is, for example, a circular shape, an elliptical shape, a quadrangular shape, a hexagonal shape, or the like. Typically, the cathode current collector has one or more oxidizing agent supply ports and the anode current collector has one or more fuel supply ports, but the configuration is not limited to this. For example, a material through which an oxidizing agent is permeable may be used as the material for the cathode current collector instead of forming the oxidizing agent supply ports. Similarly, a material through which a fuel is permeable may be used as the material for the anode current collector instead of forming the fuel supply ports. The anode current collector typically includes a fuel storage portion. This fuel storage portion may be disposed integrally with the anode current collector or may be disposed removably from the anode current collector. The fuel storage portion typically includes a cover for sealing. In this case, a fuel may be injected into the fuel storage portion by removing the cover. The fuel may be injected from the side face of the fuel storage portion without using such a cover for sealing. When the fuel storage portion is disposed removably from the anode current collector, for example, a fuel tank or fuel cartridge filled with a fuel in advance may be attached as the fuel storage portion. The fuel tank or the fuel cartridge may be disposable but is preferably a fuel tank or cartridge in which a fuel can be charged from the standpoint of effective utilization of resources. Alternatively, a used fuel tank or fuel cartridge may be replaced with a fuel tank or fuel cartridge filled with a fuel. Furthermore, for example, the fuel storage portion may be provided in the form of a sealed container having a fuel supply port and a fuel discharge port so that the fuel is continuously supplied to the sealed container from the outside through this supply port, whereby the fuel cell can be continuously used. Alternatively, the fuel cell may be used in a state in which the fuel cell floats on a fuel contained in an open fuel tank so that the anode faces downward and the cathode faces upward without providing such a fuel storage portion.

This fuel cell may have a structure in which the anode, the electrolyte, the cathode, and the cathode current collector having a structure through which an oxidizing agent can permeate are sequentially disposed around a predetermined central axis, and the anode current collector having a structure through which the fuel can permeate is disposed so as to be electrically connected to the anode. In this fuel cell, the anode may have a cylindrical shape having a circular, elliptical, or polygonal sectional shape or a columnar shape having a circular, elliptical, or polygonal sectional shape. When the anode has a cylindrical shape, the anode current collector may be disposed on the inner peripheral surface side of the anode, disposed between the anode and the electrolyte, disposed on at least one end face of the anode, or disposed at two or more positions thereof, for example. In addition, the anode may be configured to store the fuel. For example, the anode may be composed of a porous material so that the anode also functions as a fuel storage portion. Alternatively, a columnar fuel storage portion may be formed on a predetermined central axis. For example, when the anode current collector is disposed on the inner peripheral surface side of the anode, the fuel storage portion may be the space surrounded by the anode current collector or a container such as a fuel tank or fuel cartridge disposed in the space separately from the anode current collector. The container may be removably disposed or fixed. The fuel storage portion has, for example, a circular columnar shape, an elliptical columnar shape, a polygonal columnar shape such as a quadrangular or hexagonal columnar shape, or the like, but the shape is not limited to this. The electrolyte may be formed as a bag-like container so as to wrap the entire anode and anode current collector. In this case, when the fuel storage portion is completely filled with a fuel, the fuel can be brought into contact with the entire anode. In the container, at least a portion sandwiched between the cathode and the anode may be formed of an electrolyte, and other portions may be formed of a material different from the electrolyte. The container may be a sealed container having a fuel supply port and a fuel discharge port so that the fuel is continuously supplied from the outside to the container through the fuel supply port, whereby the fuel cell can be continuously used. The anode preferably has a high porosity, for example, a porosity of 60% or more such that the anode can sufficiently store the fuel therein.

A pellet electrode may be used as each of the cathode and the anode. The pellet electrode can be formed as follows using, for example, a carbon-based material (in particular, preferably a fine powder carbon material having high electrical conductivity and high surface area). Examples of the carbon-based material include KB (Ketjenblack) imparted with high electrical conductivity and a functional carbon material such as carbon nanotube, fullerene, or the like. The carbon-based material is mixed with the above-described enzyme powder (or enzyme solution), the coenzyme powder (or coenzyme solution), the electron mediator powder (or electron mediator solution), the immobilization polymer powder (or polymer solution), and the like, using an agate mortar or the like. A binder such as polyvinylidene fluoride is optionally added. The mixture is appropriately dried and then pressed into a predetermined shape to form a pellet electrode. The thickness of the pellet electrode (electrode thickness) is also determined according to need, but is, for example, about 50 μm. For example, when a coin-type fuel cell is manufactured, a pellet electrode can be formed by pressing the above-described material for forming the pellet electrode into a circular shape using a tablet machine. The diameter of the circular pellet electrode is, for example, 15 mm, but is not limited to this and determined according to need. When the pellet electrode is formed, the electrode thickness is adjusted to a desired value by controlling the amount of carbon contained in the material for forming the pellet electrode, the pressing pressure, and the like. When the cathode or the anode is inserted into a coin-type cell can, electrical contact is preferably established by, for example, inserting a metal mesh spacer between the cathode or the anode and the cell can.

Instead of the above-described method for manufacturing a pellet electrode, for example, a mixed solution of a carbon-based material, optionally a binder, and an enzyme immobilization component may be appropriately applied onto a current collector or the like and dried, and the whole may be pressed and then cut into a desired electrode size. The enzyme immobilization component includes an enzyme, a coenzyme, an electron mediator, and a polymer. Furthermore, the mixed solution is an aqueous mixed solution or an organic-solvent mixed solution.

This fuel cell can be used for almost all things that require electric power regardless of the size. Specifically, the fuel cell can be used for electronic apparatuses, mobile units (e.g., automobiles, two-wheeled vehicles, aircraft, rockets, and spacecraft), power units, construction machines, machine tools, power generation systems, cogeneration systems, and the like. In this case, the output, size, and shape of the fuel cell, the type of fuel, and the like are determined in accordance with the application and the like.

The present invention also provides an electronic apparatus including:

one or more fuel cells,

wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the mass ratio of the poly-L-lysine to the glutaraldehyde is 5:1 to 80:1.

The electronic apparatus may be basically any type of apparatus, and includes both portable-type apparatuses and stationary-type apparatuses. Specific examples thereof include cellular phones, mobile devices, robots, personal computers (including both desktop and note computers), game machines, camcorders (videotape recorders), car-mounted apparatuses, household electric appliances, and industrial products. An example of mobile devices is a personal digital assistant (PDA).

The present invention also provides an enzyme-immobilized electrode,

wherein at least glucose dehydrogenase and diaphorase are immobilized on an electrode using an immobilizing material composed of poly-L-lysine and glutaraldehyde, and

the mass ratio of the poly-L-lysine to the glutaraldehyde is 5:1 to 80:1.

The present invention also provides a method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the mass ratio of the poly-L-lysine to the glutaraldehyde is set to 5:1 to 80:1.

The descriptions of the fuel cell and the method for manufacturing a fuel cell according to the present invention apply to the above-described electronic apparatus, enzyme-immobilized electrode, and method for manufacturing an enzyme-immobilized electrode according to the present invention.

The present invention also provides a fuel cell including a structure in which a cathode and an anode face each other with a proton conductor therebetween,

wherein the anode is obtained by immobilizing at least glucose dehydrogenase and diaphorase on an electrode using an immobilizing material composed of poly-L-lysine and glutaraldehyde, and

the average molecular weight of the poly-L-lysine is 21500 or more.

The present invention also provides a method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the average molecular weight of the poly-L-lysine is set to 21500 or more.

The present invention also provides an electronic apparatus including:

one or more fuel cells,

wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the average molecular weight of the poly-L-lysine is 21500 or more.

The present invention also provides an enzyme-immobilized electrode,

wherein at least glucose dehydrogenase and diaphorase are immobilized on an electrode using an immobilizing material composed of poly-L-lysine and glutaraldehyde, and

the average molecular weight of the poly-L-lysine is 21500 or more.

The present invention also provides a method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the average molecular weight of the poly-L-lysine is set to 21500 or more.

In the inventions that specify the average molecular weight of poly-L-lysine, the average molecular weight of poly-L-lysine means a weight-average molecular weight (Mw) unless otherwise specified. Setting the average molecular weight of poly-L-lysine to 21500 or more is equivalent to setting the degree of polymerization of poly-L-lysine to 103 or more. Furthermore, the descriptions of the inventions that specify the mass ratio of poly-L-lysine to glutaraldehyde apply to the inventions that specify the average molecular weight of poly-L-lysine.

The present invention also provides a fuel cell including a structure in which a cathode and an anode face each other with a proton conductor therebetween,

wherein the anode is obtained by immobilizing at least glucose dehydrogenase and diaphorase on an electrode using an immobilizing material composed of poly-L-lysine and glutaraldehyde, and

the mass ratio of the glucose dehydrogenase to the diaphorase is 1:3 to 200:1.

The present invention also provides a method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the mass ratio of the glucose dehydrogenase to the diaphorase is set to 1:3 to 200:1.

The present invention also provides an electronic apparatus includes:

one or more fuel cells,

wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the mass ratio of the glucose dehydrogenase to the diaphorase is 1:3 to 200:1.

The present invention also provides an enzyme-immobilized electrode,

wherein at least glucose dehydrogenase and diaphorase are immobilized on an electrode using an immobilizing material composed of poly-L-lysine and glutaraldehyde, and

the mass ratio of the glucose dehydrogenase to the diaphorase is 1:3 to 200:1.

The present invention also provides a method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the mass ratio of the glucose dehydrogenase to the diaphorase is set to 1:3 to 200:1.

The descriptions of the inventions that specify the mass ratio of poly-L-lysine to glutaraldehyde apply to the inventions that specify the mass ratio of glucose dehydrogenase to diaphorase.

In the present invention having the above-described configurations, the elution of glucose dehydrogenase and diaphorase from an electrode can be prevented by setting the mass ratio of poly-L-lysine to glutaraldehyde in an immobilizing material to 5:1 to 80:1. Moreover, the elution of glucose dehydrogenase and diaphorase from an electrode can be prevented in a similar manner by setting the average molecular weight of poly-L-lysine in an immobilizing material to 21500 or more. Furthermore, the elution of glucose dehydrogenase and diaphorase from an electrode can be prevented in a similar manner by setting the mass ratio of glucose dehydrogenase to diaphorase to 1:3 to 200:1.

According to the present invention, the elution of glucose dehydrogenase and diaphorase immobilized on an electrode can be prevented, whereby the current density and its maintenance ratio can be improved, which can provide a fuel cell having high performance. Furthermore, with such an excellent fuel cell, a high-performance electronic apparatus can be realized.

### BRIEF DESCRIPTION OF DRAWINGS

FIG. 1 is a schematic line diagram showing a biofuel cell according to a first embodiment of the present invention.

FIG. 2 is a schematic line diagram showing a detailed structure of an anode of the biofuel cell according to the first embodiment of the present invention, an example of a group of enzymes immobilized on the anode, and an electron transfer reaction performed by the group of enzymes.

FIG. 3 is a schematic line diagram showing a result of an experiment performed for evaluating the biofuel cell according to the first embodiment of the present invention.

FIG. 4 is a schematic line diagram showing a result of an experiment performed for evaluating the biofuel cell according to the first embodiment of the present invention.

FIG. 5 is a schematic line diagram showing a result of an experiment performed for evaluating the biofuel cell according to the first embodiment of the present invention.

FIG. 6 is a schematic line diagram showing a result of an experiment performed for evaluating the biofuel cell according to the first embodiment of the present invention.

FIG. 7 is a schematic line diagram showing a result of an experiment performed for evaluating the biofuel cell according to the first embodiment of the present invention.

FIG. 8 is a schematic line diagram showing a result of an experiment performed for evaluating the biofuel cell according to the first embodiment of the present invention.

FIG. 9 is a schematic line diagram showing a result of an experiment performed for evaluating the biofuel cell according to the first embodiment of the present invention.

FIG. 10 is a schematic line diagram showing a result of an experiment performed for evaluating the biofuel cell according to the first embodiment of the present invention.

FIG. 11 is a schematic line diagram showing a result of an experiment performed for evaluating the biofuel cell according to the first embodiment of the present invention.

FIG. 12 is a schematic line diagram showing a result of an experiment performed for evaluating the biofuel cell according to the first embodiment of the present invention.

FIG. 13 is a schematic line diagram showing a result of an experiment performed for evaluating the biofuel cell according to the first embodiment of the present invention.

FIG. 14 is a schematic line diagram showing a result of chronoamperometry performed for evaluating the biofuel cell according to the first embodiment of the present invention.

FIG. 15 is a schematic line diagram showing the relationship between the concentration of a buffer solution and current density obtained from the result of chronoamperometry performed for evaluating the biofuel cell according to the first embodiment of the present invention.

FIG. 16 is a schematic line diagram showing the measurement system used for the measurement of chronoamperometry shown in FIG. 14.

FIG. 17 is a schematic line diagram showing the result of cyclic voltammetry performed for evaluating the biofuel cell according to the first embodiment of the present invention.

FIG. 18 is a schematic line diagram showing the measurement system used for the measurement of cyclic voltammetry shown in FIG. 17.

FIG. 19 is a schematic line diagram showing the result of chronoamperometry performed using a buffer solution containing imidazole and a NaH₂PO₄ buffer solution in the biofuel cell according to the first embodiment of the present invention.

FIG. 20 is a schematic line diagram for describing a mechanism with which a high current can be constantly obtained when a buffer solution containing imidazole is used in the biofuel cell according to the first embodiment of the present invention.

FIG. 21 is a schematic line diagram for describing a mechanism with which current is decreased when a NaH₂PO₄ buffer solution is used in the biofuel cell according to the first embodiment of the present invention.

FIG. 22 is a schematic line diagram showing the relationship between the concentration of a buffer solution and current density when various buffer solutions are used in the biofuel cell according to the first embodiment of the present invention.

FIG. 23 is a schematic line diagram showing the relationship between the concentration of a buffer solution and current density when various buffer solutions are used in the biofuel cell according to the first embodiment of the present invention.

FIG. 24 is a schematic line diagram showing the relationship between the molecular weight of a buffer substance of a buffer solution and current density when various buffer solutions are used in the biofuel cell according to the first embodiment of the present invention.

FIG. 25 is a schematic line diagram showing the relationship between the pKₐ of a buffer solution and current density when various buffer solutions are used in the biofuel cell according to the first embodiment of the present invention.

FIG. 26 is a schematic line diagram showing a specific structural example of the biofuel cell according to the first embodiment of the present invention.

FIG. 27 includes a top view, a sectional view, and a bottom view that show a biofuel cell according to a second embodiment of the present invention.

FIG. 28 is an exploded perspective view showing the biofuel cell according to the second embodiment of the present invention.

FIG. 29 is a schematic line diagram for describing a method for manufacturing the biofuel cell according to the second embodiment of the present invention.

FIG. 30 is a schematic line diagram for describing a first example of a method for using the biofuel cell according to the second embodiment of the present invention.

FIG. 31 is a schematic line diagram for describing a second example of a method for using the biofuel cell according to the second embodiment of the present invention.

FIG. 32 is a schematic line diagram for describing a third example of a method for using the biofuel cell according to the second embodiment of the present invention.

FIG. 33 is a schematic line diagram showing a biofuel cell according to a third embodiment of the present invention and a method for using the biofuel cell.

FIG. 34 includes a front view and a longitudinal sectional view that show a biofuel cell according to a fourth embodiment of the present invention.

FIG. 35 is an exploded perspective view showing the biofuel cell according to the fourth embodiment of the present invention.

### BEST MODES FOR CARRYING OUT THE INVENTION

Best modes for carrying out the invention (hereinafter referred to as “embodiments”) will now be described. Note that the description will be made in the order below.

1. First embodiment (biofuel cell)
2. Second embodiment (biofuel cell)
3. Third embodiment (biofuel cell and method for manufacturing the same)
4. Fourth embodiment (biofuel cell)

### 1. First Embodiment

### [Biofuel Cell]

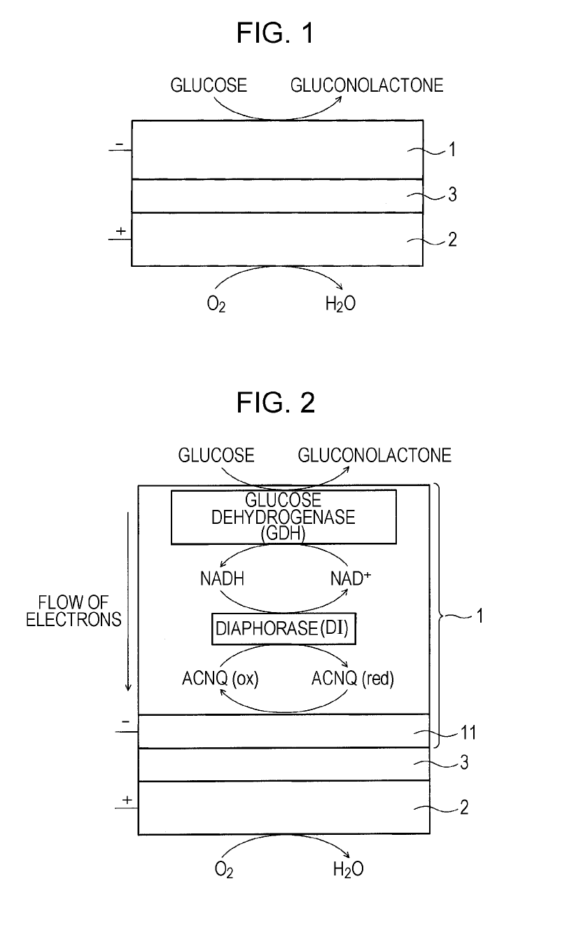

FIG. 1 schematically shows a biofuel cell according to a first embodiment of the present invention. In the biofuel cell, glucose is used as a fuel. FIG. 2 schematically shows a detailed structure of the anode of the biofuel cell, an example of a group of enzymes immobilized on the anode, and an electron transfer reaction performed by the group of enzymes.

As shown in FIG. 1, the biofuel cell has a structure in which an anode 1 and a cathode 2 face each other with an electrolyte layer 3 therebetween, the electrolyte layer 3 having no electron conductivity and conducting only protons. At the anode 1, glucose supplied as a fuel is decomposed by an enzyme to extract electrons and also generate protons (H⁺). At the cathode 2, water is generated using protons transported from the anode 1 through the electrolyte layer 3, electrons transferred from the anode 1 through an external circuit, and oxygen in the air or the like.

At the anode 1, an oxidase that contributes to the decomposition of glucose, a coenzyme, a coenzyme oxidase, an electron mediator, and the like are immobilized on an electrode 11 (refer to FIG. 2) composed of, for example, porous carbon with an immobilizing material (not shown). Herein, an oxidase that contributes to the decomposition of glucose is glucose dehydrogenase (GDH). A coenzyme is reduced with an oxidation reaction in the decomposition process of glucose so as to become a reduced form. Examples of the coenzyme include NAD⁺ and NADP⁺. A coenzyme oxidase oxidizes the reduced form (e.g., NADH and NADPH) of a coenzyme, and is diaphorase (DI). An electron mediator is configured to receive, from diaphorase, electrons generated with the oxidation of the coenzyme and deliver the electrons to the electrode 11. An immobilizing material is composed of poly-L-lysine (PLL) and glutaraldehyde (GA). Herein, the mass ratio between poly-L-lysine and glutaraldehyde in the immobilizing material is preferably selected to 5:1 to 80:1. Furthermore, the average molecular weight of poly-L-lysine in the immobilizing material is preferably selected to 21500 or more. Moreover, the mass ratio between glucose dehydrogenase and diaphorase immobilized on the electrode 11 is preferably selected to 1:3 to 200:1. For example, FIG. 2 shows the case where a coenzyme in which a reduced form is produced with an oxidation reaction in the decomposition process of glucose is NAD⁺ and an electron mediator configured to receive, from diaphorase, electrons generated with the oxidation of the coenzyme and deliver the electrons to the electrode 11 is ACNQ.

In the presence of glucose dehydrogenase (GDH) as an enzyme that contributes to the decomposition of glucose, for example, β-D-glucose can be oxidized into D-glucono-δ-lactone.

Furthermore, D-glucono-δ-lactone can be decomposed into 2-keto-6-phospho-D-gluconate in the presence of two enzymes, namely gluconokinase and phosphogluconate dehydrogenase (PhGDH). In other words, D-glucono-δ-lactone is converted into D-gluconate through hydrolysis. D-gluconate is phosphorylated into 6-phospho-D-gluconate by hydrolyzing adenosine triphosphate (ATP) into adenosine diphosphate (ADP) and phosphoric acid in the presence of gluconokinase. Through the action of the oxidase PhGDH, 6-phospho-D-gluconate is oxidized into 2-keto-6-phospho-D-gluconate.

Furthermore, glucose can be decomposed into CO₂ using glucose metabolism without using the above-described decomposition process. The decomposition process using the glucose metabolism is broadly divided into the decomposition of glucose and the generation of pyruvic acid through a glycolytic pathway and a TCA cycle, which are well-known reaction systems.

The oxidation reaction in the decomposition process of monosaccharides proceeds with the reduction reaction of a coenzyme. In most cases, the coenzyme is determined in accordance with an enzyme that acts in the decomposition process. If GDH is used as an enzyme, NAD⁺ is used as a coenzyme. That is, when β-D-glucose is oxidized into D-glucono-δ-lactone through the action of GDH, NAD⁺ is reduced to NADH to generate H⁺.

The generated NADH is immediately oxidized into NAD⁺ in the presence of diaphorase (DI) to generate two electrons and H⁺. Thus, two electrons and two H⁺ are generated per glucose molecule through one step of oxidation reaction. Four electrons and four H⁺ are generated in total through two steps of oxidation reaction.

The electrons generated through the above-described process are delivered from diaphorase to the electrode 11 through an electron mediator and H⁺ are transported to the cathode 2 through the electrolyte layer 3.

The electron mediator performs the transference of electrons to/from the electrode 11. The output voltage of biofuel cells depends on the oxidation-reduction potential of the electron mediator. That is, to achieve a higher output voltage, an electron mediator having a more negative potential may be selected for the anode 1 side. However, the reaction affinity of the electron mediator to the enzyme, the electron-exchange rate with the electrode 11, the structural stability to inhibiting factors (e.g., light and oxygen), and the like also have to be considered. From these standpoints, 2-amino-3-carboxy-1,4-naphthoquinone (ACNQ), vitamin K3 (VK3), or the like is preferably used as the electron mediator that is immobilized on the anode 1. Examples of other usable electron mediators include compounds having a quinone skeleton; metal complexes of osmium (Os), ruthenium (Ru), iron (Fe), cobalt (Co), or the like; viologen compounds such as benzyl viologen; compounds having a nicotinamide structure; compounds having a riboflavin structure; and compounds having a nucleotide-phosphoric acid structure.

The electrolyte layer 3 is a proton conductor that transports H⁺ generated at the anode 1 to the cathode 2, and is constituted by a material that has no electron conductivity and that can transport H⁺. The electrolyte layer 3 may be composed of a material that is adequately selected from the materials mentioned above, for example. In such a case, the electrolyte layer 3 contains a buffer solution containing a compound having an imidazole ring as a buffer substance. The compound having an imidazole ring can be adequately selected from the compounds mentioned above, for example, imidazole. The concentration of the compound having an imidazole ring, which serves as a buffer substance, is selected depending on cases, and the concentration is preferably 0.2 M or more and 3 M or less. In such a case, a high buffering capacity can be achieved and the capability intrinsic to the enzyme can be satisfactorily exhibited even when the biofuel cell is operated at a high output. Furthermore, a too high or too low ionic strength (I.S.) adversely affects the enzyme activity. In consideration of also the electrochemical responsiveness, an appropriate ionic strength, for example, about 0.3 is preferable. However, as for the pH and the ionic strength, optimum values are different depending on the enzymes used, and are not limited to the above-described values.

The cathode 2 is configured so that an oxygen reductase and an electron mediator that receives and transfers electrons from/to an electrode are immobilized on the electrode composed of, for example, porous carbon. For example, bilirubin oxidase (BOD), laccase, ascorbic acid oxidase, or the like can be used as the oxygen reductase. As the electron mediator, for example, hexacyanoferrate ions generated by ionization of potassium hexacyanoferrate can be used. The electron mediator is preferably immobilized at a sufficiently high concentration, for example, 0.64×10⁻⁶ mol/mm² or more on average.

At the cathode 2, oxygen in the air is reduced by H⁺ transferred from the electrolyte layer 3 and electrons sent from the anode 1 in the presence of the oxygen reductase to produce water.

In the fuel cell having the above-described configuration, when glucose is supplied to the anode 1 side in a form of a glucose solution or the like, the glucose is decomposed by a catabolic enzyme containing an oxidase. As a result of the involvement of the oxidase in this decomposition process of monosaccharides, electrons and H⁺ can be generated on the anode 1 side and a current can be generated between the anode 1 and the cathode 2.

Next, the result of electrochemical measurement for a single electrode of an enzyme/coenzyme/electron mediator-immobilized electrode that is used as the anode 1 will be described.

The enzyme/coenzyme/electron mediator-immobilized electrode was prepared as follows.

First, various solutions were prepared as described below. As a buffer solution for preparing the solutions, a 100 mM sodium dihydrogen phosphate (NaH₂PO₄) buffer solution (I.S.=0.3, pH=8.0) was used.

GDH Enzyme Buffer Solution (1)

Fifteen milligrams of GDH(NAD-dependent, EC 1.1.1.47, produced by Amano Enzyme Inc., 77.6 U/mg) was weighed and dissolved in 100 μL of the 100 mM sodium dihydrogen phosphate buffer solution to prepare a GDH enzyme buffer solution (1). The buffer solution in which the enzyme is to be dissolved is preferably refrigerated at 4° C. or lower until just before the use thereof and the enzyme buffer solution is also preferably refrigerated at 4° C. or lower if possible.

DI Enzyme Buffer Solution (2)

Fifteen milligrams of DI (EC 1.6.99. produced by Amano Enzyme Inc., 1030 U/mg) was weighed and dissolved in 100 μL of the 100 mM sodium dihydrogen phosphate buffer solution to prepare a DI enzyme buffer solution (2). The buffer solution in which the enzyme is to be dissolved is preferably refrigerated at 4° C. or lower until just before the use thereof and the enzyme buffer solution is also preferably refrigerated at 4° C. or lower if possible.

NADH Buffer Solution (3)

Forty-one milligrams of NADH (produced by Sigma Aldrich Corporation, N-8129) was weighed and dissolved in 64 μL of the 100 mM sodium dihydrogen phosphate buffer solution to prepare an NADH buffer solution (3).

ANQ Acetone Solution (4)

Six point two milligrams of 2-amino-1,4-naphthoquinone (ANQ) (synthetic product) was weighed and dissolved in 600 μL of an acetone solution to prepare an ANQ acetone solution (4).

PLL Aqueous Solution (5)

An appropriate amount of poly-L-lysine hydrobromide (PLL) (produced by Sigma Aldrich Corporation, P-1524, Mw=513 k) was weighed and dissolved in ion exchange water to achieve 1.0 wt % and to prepare a PLL aqueous solution (5).

GA Aqueous Solution (6)

An appropriate amount of glutaraldehyde (GA) (produced by KANTO CHEMICAL Co., Inc., 17026-02, 50% aqueous solution) was weighed and dissolved in ion exchange water to achieve 0.125 wt % and to prepare a GA aqueous solution (6).

The solutions (1) to (4) prepared as described above were sampled in amounts described below and mixed. The mixture solution was applied with a micropipette or the like on a glassy carbon electrode and then dried as needed to prepare an enzyme/coenzyme/electron mediator-coated electrode. The glassy carbon electrode is produced by BAS corporation and is obtained by forming a plastic with a thickness of 1.5 mm around an electrode portion with a diameter of 3 mm so as to have a diameter of 6 mm.

GDH enzyme buffer solution (1): 6.2 μL (the total mass of GDH is 933 μg and the mass per unit area is 132 μg/mm²)

DI enzyme buffer solution (2): 3.1 μL (the total mass of DI is 467 μg and the mass per unit area is 66.1 μg/mm²)

NADH buffer solution (3): 2.0 μL

ANQ acetone solution (4): 18.7 μL

The PLL aqueous solution (5) was applied on the enzyme/coenzyme/electron mediator-coated electrode and then drying was performed as needed. Subsequently, the GA aqueous solution (6) was applied and then drying was performed as needed to prepare an enzyme/coenzyme/electron mediator-immobilized electrode. The enzyme/coenzyme/electron mediator-immobilized electrode was prepared by changing the application amounts of the PLL aqueous solution (5) and the GA aqueous solution (6) so that there are nine mass ratios, in the range from 1:2 to 80:1, of PLL to GA in an immobilizing film to be obtained in the end. However, the total mass of PLL and GA in the immobilizing film was fixed to 319 μg. Furthermore, the mass ratio of GDH to DI was fixed to 2:1 and the total mass of GDH and DI was fixed to 319 μg. The mass of NADH was 1.28 mg and the mass of ANQ was 195 μg.

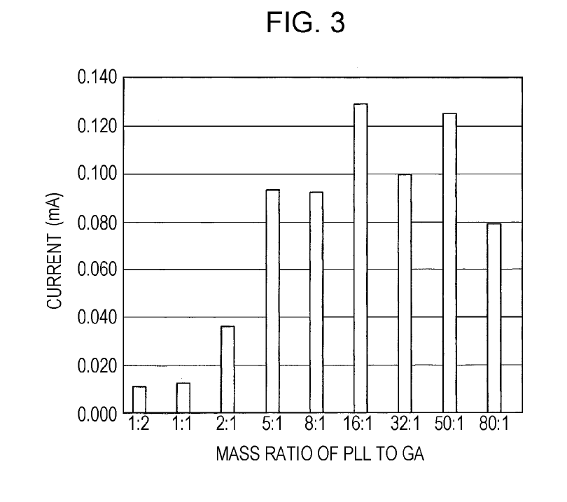

A potential of the thus-prepared enzyme/coenzyme/electron mediator-immobilized electrode was set to 0.1 V, which is a sufficiently higher potential than the oxidation-reduction potential of the electron mediator, and chronoamperometry (CA) was performed on the electrode with respect to a reference electrode Ag|AgCl using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 0.4 M. FIG. 3 shows the measurement results of current after chronoamperometry was performed for one hour (3600 seconds).

As is clear from FIG. 3, when the mass ratio of PLL to GA is in the range from 5:1 to 80:1, a high electric current of about 80 μA or higher is achieved even after one hour. In particular when the mass ratio is 16:1, an extremely high current of 130 μA is achieved. Thus, it is understood that a mass ratio of PLL to GA of 5:1 to 80:1 can provide high current and its maintenance ratio.

It is also found from the experiment performed separately that, when the total mass of PLL and GA is 300 to 1500 μg, high current is achieved.

Next, the examination results of the mass ratio of GDH to DI in the enzyme/coenzyme/electron mediator-immobilized electrode will be described.

An enzyme/coenzyme/electron mediator-immobilized electrode was prepared by changing the application amounts of the GDH enzyme buffer solution (1) and the DI enzyme buffer solution (2) so that there are nine mass ratios, in the range from 1:3 to 10:1, of GDH to DI in an immobilizing film to be obtained in the end. Herein, the same glassy carbon electrode as that described above was used as an electrode. Furthermore, the total mass of GDH and DI in the immobilizing film was fixed to 600 μg. Moreover, the application amount of the PLL aqueous solution (5) was 30 μL and the application amount of the GA aqueous solution (6) was 15 μL. The mass of NADH was 1.28 mg and the mass of ANQ was 195 μg.

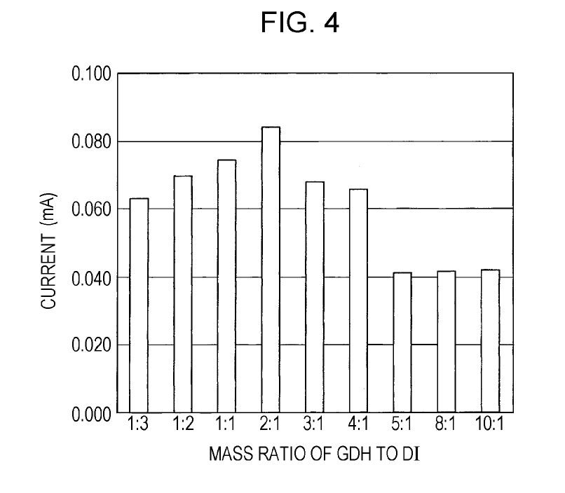

Chronoamperometry (CA) was performed on the thus-prepared enzyme/coenzyme/electron mediator-immobilized electrode using the same measurement solution and conditions as those described above. FIG. 4 shows the measurement results of current after chronoamperometry was performed for one hour (3600 seconds).

As is clear from FIG. 4, when the mass ratio of GDH to DI is in the range from 1:3 to 4:1, a high electric current of 60 μA or higher is achieved even after one hour. In particular when the mass ratio is 2:1, an extremely high current of 80 μA or higher is achieved. Thus, it is understood that a mass ratio of GDH to DI of 1:3 to 4:1 can provide high current and its maintenance ratio. Herein, when the mass ratio of GDH to DI is converted into unit (U) of enzyme activity, GDH can be converted at 77.6 U/mg and DI can be converted at 1030 U/mg. The mass ratios of GDH to DI from 1:3 to 4:1 can be expressed by the enzyme activity ratios from 1:39.8 to 1:3.3.

It is also found from the experiment performed separately that, when the total mass of GDH and DI is 500 to 3000 μg, particularly 1000 to 2500 μg, high current is achieved.

Herein, U (unit) is an indicator that indicates enzyme activity and, for example, can be obtained as described below.

<Diaphorase (DI)>

Reaction Formula

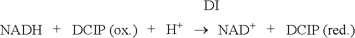

The elimination of DCIP (ox.) is measured by spectrophotometry at a wavelength of 600 nm.

Under the conditions described below, 1 U (unit) can be defined as the amount of an enzyme that reduces 1 μmol of DCIP (ox.) per minute.

Reagent

Solution A: 60 mM Tris-HCl Buffer Solution (pH 8.5)

Solution B: NADH Solution

Eighty-five point one milligrams of β-NADH (produced by Oriental Yeast Co., Ltd.) is dissolved in 10 mL of deionized water.

Solution C: 2,6-dichlorophenolindophenol (DCIP) Solution

Two point three five milligrams of DCIP sodium salt dihydrate is dissolved in water.

Solution D: Enzyme Solution

Twenty milligrams of diaphorase “Amano” is dissolved in cooled deionized water.

The concentration of the enzyme solution is adjusted such that ΔOD/min is 0.020±0.005.

Measurement Method

Solution A: 2.5 mL, solution B: 0.25 mL, and solution C, 0.25 mL are inserted into a cuvette (d=10 mm) with a pipette and held at 30±0.1° C. for 5 minutes. Subsequently, solution D: 0.1 mL is inserted into the cuvette with a pipette, and the reaction solution is immediately mixed thoroughly. The mixed solution is held at 30±0.1° C. Next, exactly after 0.5 min and 1 min of the addition of the solution D, the absorbance (A0.5 and A1.0) of the reaction solution is measured at a wavelength of 600 nm. As a blank, instead of the enzyme solution D, deionized water is inserted into another cuvette (d=10 mm) with a pipette, and the absorbance (Ab0.5 and Ab1.0) is measured by the same method.

Calculation Method

Unit per weight (U/mg) of diaphorase is defined using the calculation formula below.

Diaphorase activity (U/mg)=[{(A0.5−A1.0)−(Ab0.5−Ab1.0)}/0.5]×(1/19.0)×3.10×(Dm/0.1)

where
0.5: Reaction time
19.0: Millimolar extinction coefficient of DCIP (wavelength 600 nm)
3.1: Final volume of reaction solution
0.1: Volume of enzyme solution
Dm: Dilution ratio of enzyme solution

### <Glucose Dehydrogenase (GDH)>

Reaction Formula

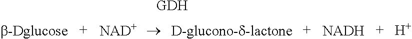

The generation of NADH is measured by spectrophotometry at a wavelength of 340 nm.

Under the conditions described below, 1 U (unit) can be defined as the amount of an enzyme that generates 1 μmmol of NADH per minute.

Reagent

Solution A: 0.1 M Tris-HCl Buffer Solution (pH 8.5)

Solution B: 0.1 M Phosphate Buffer Solution (KH₂PO₄—Na₂HPO₄, pH 7.0)

Solution C: Substrate Solution

Six point seven five grams of glucose is dissolved in deionized water to prepare a solution having a volume of 25 mL. The substrate solution is used after left for 30 minutes or longer. Only a substrate solution stored at room temperature for shorter than two weeks can be used.

Solution D: NAD Solution

Forty milligrams of β-NAD (produced by Oriental Yeast Co., Ltd.) is dissolved in 1 mL of deionized water. Only an NAD solution stored at 2 to 8° C. for shorter than one week can be used.

Solution E: Enzyme solution

Twenty milligrams of glucose dehydrogenase “Amano” is dissolved in a cooled solution B. The concentration of the enzyme solution is adjusted such that ΔOD/min is 100±0.020.

Measurement Method

Solution A: 2.7 mL, solution C, 0.2 mL, and solution D: 0.1 mL are inserted into a cuvette (d=10 mm) with a pipette and held at 25±0.1° C. for 5 minutes. Subsequently, solution E: 0.05 mL is inserted into the cuvette with a pipette, and the reaction solution is immediately mixed thoroughly. The mixed solution is held at 25±0.1° C. Next, exactly after 2 min and 5 min of the addition of the solution E, the absorbance (A2 and A5) of the reaction solution is measured at a wavelength of 340 nm. As a blank, instead of the enzyme solution D, the solution B is inserted into another cuvette (d=10 mm) with a pipette, and the absorbance (Ab2 and Ab5) is measured by the same method.

Calculation Method

Unit per weight (U/mg) of glucose dehydrogenase is defined using the calculation formula below.

Glucose dehydrogenase activity (U/mg)=[{(A5−A2)−(Ab5−Ab2)}/3]×(1/6.22)×3.05×(Dm/0.05)

where
3: Reaction time
6.22: Millimolar extinction coefficient of NADH (wavelength 340 nm)
3.05: Final volume of reaction solution
0.05: Volume of enzyme solution
Dm: Dilution ratio of enzyme solution

The mass ratio of GDH to DI in the enzyme/coenzyme/electron mediator-immobilized electrode was considered on the basis of the measurement of linear sweep voltammetry (LSV), instead of chronoamperometry (CA), in a wider range than that of the above-described measurement.

An enzyme/coenzyme/electron mediator-immobilized electrode was prepared by changing the application amounts of the GDH enzyme buffer solution (1) and the DI enzyme buffer solution (2) so that there are 24 mass ratios, in the range from 1:300 to 400:1, of GDH to DI in an immobilizing film to be obtained in the end. Herein, the same glassy carbon electrode as that described above was used as an electrode. The total mass of GDH and DI in the immobilizing film was fixed to 600 μg. Moreover, the application amount of the PLL aqueous solution (5) was 30 μL and the application amount of the GA aqueous solution (6) was 15 μL. The mass of NADH was 1.28 mg and the mass of ANQ was 195 μg.

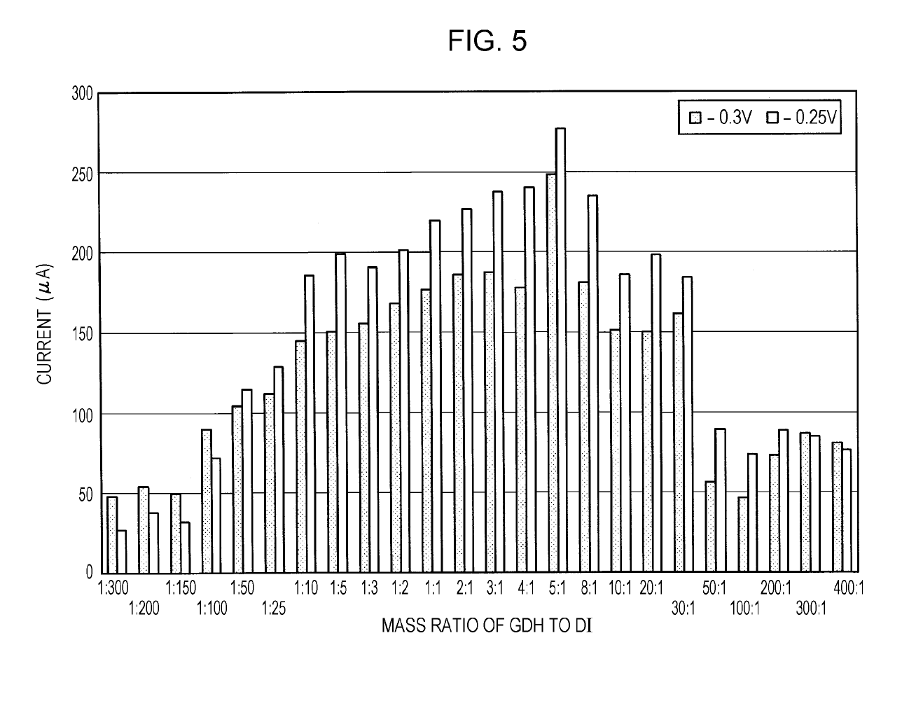

Linear sweep voltammetry (LSV) (−0.6 to +0.3 V, 1 mV/s) was performed on the thus-prepared enzyme/coenzyme/electron mediator-immobilized electrode using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 0.4 M. FIG. 5 shows the measurement results of current at −0.3 V and −0.25 V of LSV.

As is clear from FIG. 5, when the mass ratio of GDH to DI is in the range from 1:3 to 30:1, a high electric current of about 150 μA or higher is achieved. In particular when the mass ratio is 5:1, a highest current of about 250 μA or higher is achieved. Thus, it is understood that a mass ratio of GDH to DI of 1:3 to 30:1 can provide high current and its maintenance ratio.

Next, the examination results about the average molecular weight of PLL in the enzyme/coenzyme/electron mediator-immobilized electrode will be described.

An enzyme/coenzyme/electron mediator-immobilized electrode was prepared in the same manner as that described above except that the viscosity-average molecular weight (Mv) of PLL of the PLL aqueous solution (5) was changed in the range of 0.5 to 513 k (500 to 513000). Herein, the same glassy carbon electrode as that described above was used as an electrode. Furthermore, PLL produced by Sigma Aldrich Corporation and named in accordance with viscosity-average molecular weight was used. The mass of GDH in the immobilizing film was 933 μg and the mass of DI was 467 μg. The mass of NADH was 1.28 mg and the mass of ANQ was 195 μg. Furthermore, the application amount of the PLL aqueous solution (5) was 28 μL and the application amount of the GA aqueous solution (6) was 14 μL.

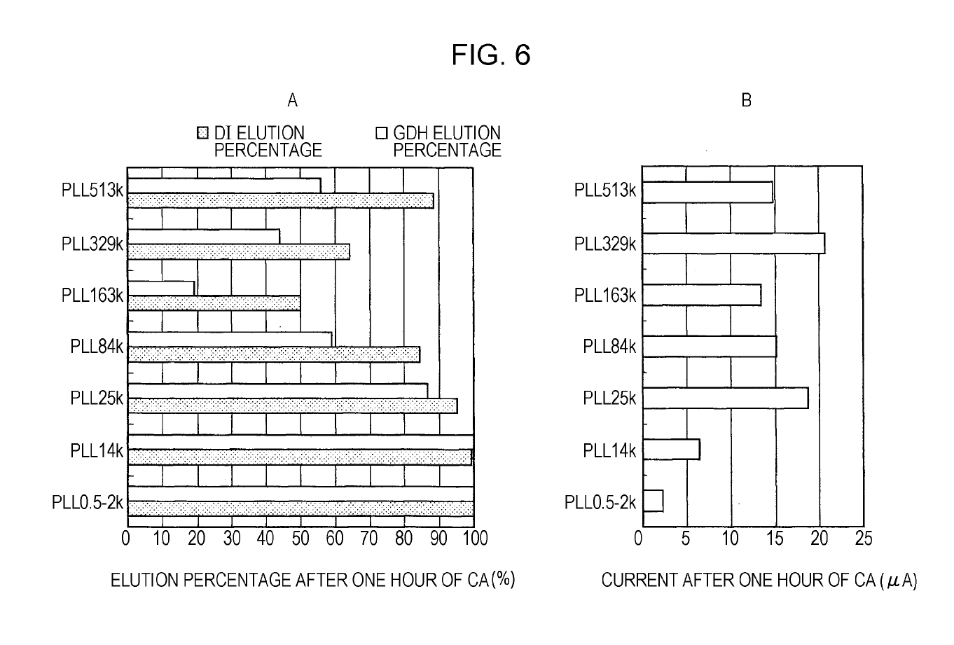

Chronoamperometry (CA) was performed on the thus-prepared enzyme/coenzyme/electron mediator-immobilized electrode using the same measurement solution and conditions as those described above. FIG. 6B shows the measurement results of current after chronoamperometry was performed for one hour (3600 seconds).

As is clear from FIG. 6B, when the viscosity-average molecular weight of PLL is 25 k (25000) or more, a high current of 13 μA or higher is achieved even after one hour. Thus, it is understood that a viscosity-average molecular weight of PLL of 25 k (25000) or more can provide high current and its maintenance ratio. As described below, since a viscosity-average molecular weight of 25000 corresponds to a weight-average molecular weight of about 21500, it can be said that a weight-average molecular weight of PLL of 21500 or more can provide high current and its maintenance ratio.

Furthermore, SDS-PAGE (gel electrophoresis that uses polyacrylamide gel, in which electrophoresis is performed by adding sodium dodecyl sulfate (SDS) in a system to control the charge density of molecules in a sample solution) was performed on the thus-prepared enzyme/coenzyme/electron mediator-immobilized electrode to analyze the elution percentages of GDH and DI. FIG. 6A shows the results.

As is clear from FIG. 6A, when the viscosity-average molecular weight of PLL is 25 k (25000) or more, the elution of both GDH and DI is suppressed even after one hour, which corresponds to the result shown in FIG. 6B that a high current is achieved when the viscosity-average molecular weight of PLL is 25 k (25000) or more.

The above are the results obtained when a glassy carbon electrode was used. Next, the results obtained by performing the same evaluations as those described above using a porous carbon (PC) electrode will be described.

First, various solutions and a porous carbon electrode on which a conductive paint (carbon-based material) was applied were prepared as described below. As a buffer solution for preparing the solutions, a 100 mM sodium dihydrogen phosphate (NaH₂PO₄) buffer solution (I.S.=0.3, pH=8.0) was used.

GDH Enzyme Buffer Solution (1)

Fifteen milligrams of GDH (NAD-dependent, EC 1.1.1.47, produced by Amano Enzyme Inc., 77.6 U/mg) was weighed and dissolved in 100 μL of the 100 mM sodium dihydrogen phosphate buffer solution to prepare a GDH enzyme buffer solution (1). The buffer solution in which the enzyme is to be dissolved is preferably refrigerated at 4° C. or lower until just before the use thereof and the enzyme buffer solution is also preferably refrigerated at 4° C. or lower if possible.

DI Enzyme Buffer Solution (2)

Fifteen milligrams of DI (EC 1.6.99. produced by Amano Enzyme Inc., 1030 U/mg) was weighed and dissolved in 100 μL of the 100 mM sodium dihydrogen phosphate buffer solution to prepare a DI enzyme buffer solution (2). The buffer solution in which the enzyme is to be dissolved is preferably refrigerated at 4° C. or lower until just before the use thereof and the enzyme buffer solution is also preferably refrigerated at 4° C. or lower if possible.

NADH Buffer Solution (3)

Forty-one milligrams of NADH (produced by Sigma Aldrich Corporation, N-8129) was weighed and dissolved in 64 μL of the 100 mM sodium dihydrogen phosphate buffer solution to prepare a NADH buffer solution (3).

ANQ Acetone Solution (4)

Six point two milligrams of 2-amino-1,4-naphthoquinone

(ANQ) (synthetic product) was weighed and dissolved in 600 μL of an acetone solution to prepare an ANQ acetone solution (4).

PLL Aqueous Solution (5)

An appropriate amount of poly-L-lysine hydrobromide (PLL) (produced by Sigma Aldrich Corporation, P-1524, Mw=513 k) was weighed and dissolved in ion exchange water to achieve 4.0 wt % and to prepare a PLL aqueous solution (5).

GA Aqueous Solution (6)

An appropriate amount of glutaraldehyde (abbreviated as GA) (produced by Wako Pure Chemical Industries, Ltd., 071-02031, 10% aqueous solution) was weighed and dissolved in ion exchange water to achieve 0.0625 wt % and to prepare a GA aqueous solution (6).

Porous Carbon (PC) Electrode on which a Conductive Paint is Applied

A conductive paint was dissolved in 2-butanone

(produced by Wako Pure Chemical Industries, Ltd., 133-02506) so as to have a volume ratio of 5:1. The conductive paint was applied on a porous carbon electrode cut into a one-centimeter square, so as to have a dry weight of about 105 to 108 mg, and then dried for one night. The conductive paint contains 13 to 18% of natural graphite, 3 to 8% of polyvinyl butyral as a binder, 8.4% of carbon black, and 69.48% of methyl isobutyl ketone as an organic solvent. The porous carbon electrode has a size of 1 cm×1 cm×2 mm, a porosity of 60%, and a weight of about 95 to 98 mg.

Ozone cleaning treatment was performed on the top face and the bottom face of the porous carbon electrode on which the conductive paint was applied as described above for 20 minutes each. The solutions (1) to (4) prepared as described above were sampled in amounts described below and mixed. The mixture solution was applied with a micropipette or the like on the top face and the bottom face of the porous carbon electrode subjected to ozone cleaning treatment so that the top face and the bottom face each had half the amount of the mixture solution. Subsequently, drying was performed in a dry oven at 40° C. for 15 minutes to prepare an enzyme/coenzyme/electron mediator-coated electrode.

GDH enzyme buffer solution (1): 53.5 μL (the total mass of GDH is 8.00 mg and the mass per projected area is 8.00 mg/cm²)

DI enzyme buffer solution (2): 13.4 μL (the total mass of DI is 2.00 mg and the mass per projected area is 2.00 mg/cm²)

NADH buffer solution (3): 6.00 μL (the total mass of NADH is 3.84 mg and the mass per projected area is 3.84 mg/cm²)

ANQ acetone solution (4): 74.8 μL (the total mass of ANQ is 780 μg and the mass per projected area is 780 μg/cm²)

The PLL aqueous solution (5) was applied on the top face and the bottom face of the enzyme/coenzyme/electron mediator-coated electrode so that the top face and the bottom face each had half the amount described below, and then drying was performed in a dry oven at 40° C. for 15 minutes. Subsequently, the GA aqueous solution (6) was applied on the top face and the bottom face of the electrode so that the top face and the bottom face each had half the amount described below, and then drying was performed in a dry oven at 40° C. for 15 minutes to prepare an enzyme/coenzyme/electron mediator-immobilized electrode.

PLL aqueous solution (5): 69.0 μL (the total mass of PLL is 2.76 mg and the mass per projected area is 2.76 mg/cm²)

GA aqueous solution (6): 67.2 μL (the total mass of GA is 42.0 μg and the mass per projected area is 42.0 μg/cm²)

The enzyme/coenzyme/electron mediator-immobilized electrode was prepared by changing the application amounts of the PLL aqueous solution (5) and the GA aqueous solution (6) so that there are 12 mass ratios, in the range from 1:1 to 80:1, of PLL to GA in an immobilizing film to be obtained in the end. However, the mass ratio of GDH to DI in the immobilizing film was fixed to 4:1. The total mass of GDH and DI was fixed to 10 mg. The mass of NADH was fixed to 5.12 mg. The mass of ANQ was fixed to 780 μg. The total mass of PLL and GA was fixed to 2.8 mg.

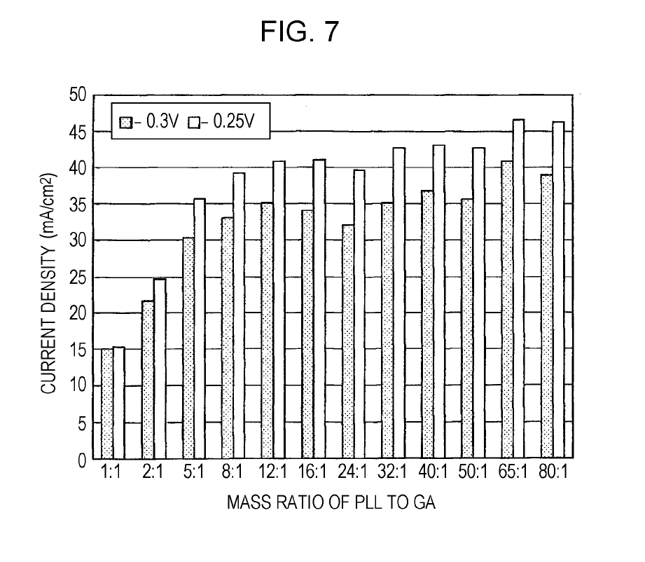

Linear sweep voltammetry (LSV) (−0.6 to +0.3 V, 1 mV/s) was performed on the enzyme/coenzyme/electron mediator-immobilized electrode using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 1.0 M. FIG. 7 shows the measurement results of current density (current density per projected area of an electrode).

As is clear from FIG. 7, when the mass ratio of PLL to GA is in the range from 5:1 to 80:1, a high current density of 30 mA/cm² or higher is achieved. In particular when the mass ratio is 65:1, the highest current density is achieved. Thus, it is understood that a mass ratio of PLL to GA of 5:1 to 80:1 can provide high current and its maintenance ratio.

It is also found from the experiment performed separately that, when the total mass of PLL and GA is 1 to 3 mg, high current density is achieved.

Next, the examination results of the mass ratio of GDH to DI in the enzyme/coenzyme/electron mediator-immobilized electrode will be described.

An enzyme/coenzyme/electron mediator-immobilized electrode was prepared by changing the application amounts of the GDH enzyme buffer solution (1) and the DI enzyme buffer solution (2) so that there are seven mass ratios, in the range from 1:3 to 10:1, of GDH to DI in an immobilizing film to be obtained in the end. Herein, the same porous carbon electrode as that described above was used as an electrode. The total mass of GDH and DI in the immobilizing film was fixed to 5.58 mg. Moreover, the application amount of the PLL aqueous solution (5) was 70 μL and the application amount of the GA aqueous solution (6) was 76 μL. The mass of NADH was 5.12 mg and the mass of ANQ was 780 μg.

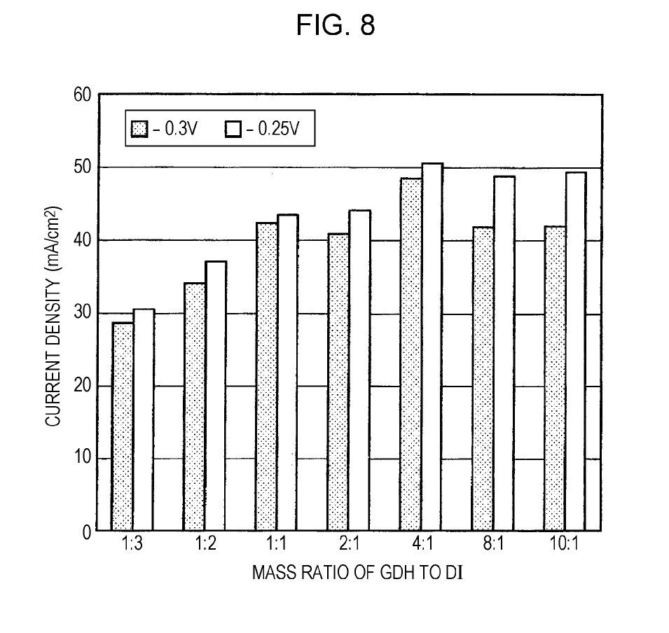

Linear sweep voltammetry (LSV) (−0.5 to +0.3 V, 1 mV/s) was performed on an electrode obtained by placing the thus-prepared enzyme/coenzyme/electron mediator-immobilized electrode on top of the other, using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 0.4 M. FIG. 8 shows the measurement results of current density at −0.3 V and −0.25 V of LSV.

As is clear from FIG. 8, when the mass ratio of GDH to DI is in the range from 1:1 to 10:1, a high current density of 40 mA/cm² or higher is achieved. In particular when the mass ratio is 4:1, an extremely high current density of about 50 mA/cm² is achieved. Thus, it is understood that a mass ratio of GDH to DI of 1:1 to 10:1 can provide high current and its maintenance ratio. Herein, when the mass ratio of GDH to DI is converted into unit (U) of enzyme activity, GDH can be converted at 77.6 U/mg and DI can be converted at 1030 U/mg. The mass ratios of GDH to DI from 1:1 to 10:1 can be expressed by the enzyme activity ratios from 1:13.3 to 1:1.33.

It is also found from the experiment performed separately that, when the total mass of GDH and DI is 5 to 15 mg, high current is achieved.

The mass ratio of GDH to DI in the enzyme/coenzyme/electron mediator-immobilized electrode was considered on the basis of the measurement of linear sweep voltammetry (LSV) in a wider range than that of the above-described measurement.

An enzyme/coenzyme/electron mediator-immobilized electrode was prepared by changing the application amounts of the GDH enzyme buffer solution (1) and the DI enzyme buffer solution (2) so that there are 13 mass ratios, in the range from 1:300 to 400:1, of GDH to DI in an immobilizing film to be obtained in the end. Herein, the same porous carbon electrode as that described above was used as an electrode. The total mass of GDH and DI in the immobilizing film was fixed to 5.58 mg. Moreover, the application amount of the PLL aqueous solution (5) was 70 μL and the application amount of the GA aqueous solution (6) was 76 μL. The mass of NADH was 5.12 mg and the mass of ANQ was 780 μg.

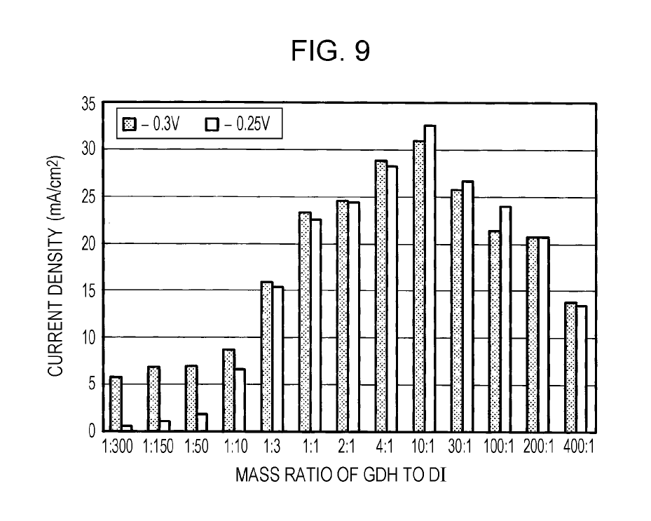

Linear sweep voltammetry (LSV) (−0.6 to +0.3 V, 1 mV/s) was performed on the thus-prepared enzyme/coenzyme/electron mediator-immobilized electrode using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 0.4 M. FIG. 9 shows the measurement results of current density at −0.3 V and −0.25 V of LSV.

As is clear from FIG. 9, when the mass ratio of GDH to DI is in the range from 1:3 to 200:1, a high current density of 15 mA/cm² or higher is achieved. In particular when the mass ratio is 4:1 to 10:1, an extremely high current density of about 28 to 32 mA/cm² is achieved. Thus, it is understood that a mass ratio of GDH to DI of 1:3 to 200:1 can provide high current and its maintenance ratio.

It is also found from the experiment performed separately that, when the total mass of GDH and DI is 5 to 15 mg, high current is achieved.

Next, the examination results about the average molecular weight of PLL in the enzyme/coenzyme/electron mediator-immobilized electrode will be described.

An enzyme/coenzyme/electron mediator-immobilized electrode was prepared in the same manner as that described above except that the viscosity-average molecular weight (Mv) of PLL of the PLL aqueous solution (5) was changed in the range of 0.5 to 513 k (500 to 513000). Herein, the same porous carbon electrode as that described above was used as an electrode. Furthermore, PLL produced by Sigma Aldrich Corporation and named in accordance with viscosity-average molecular weight was used. The mass of GDH in the immobilizing film was 3.73 mg and the mass of DI was 1.87 mg. The mass of NADH was 5.12 mg and the mass of ANQ was 780 μg. Furthermore, the application amount of the PLL aqueous solution (5) was 76 μL and the application amount of the GA aqueous solution (6) was 76 μL.

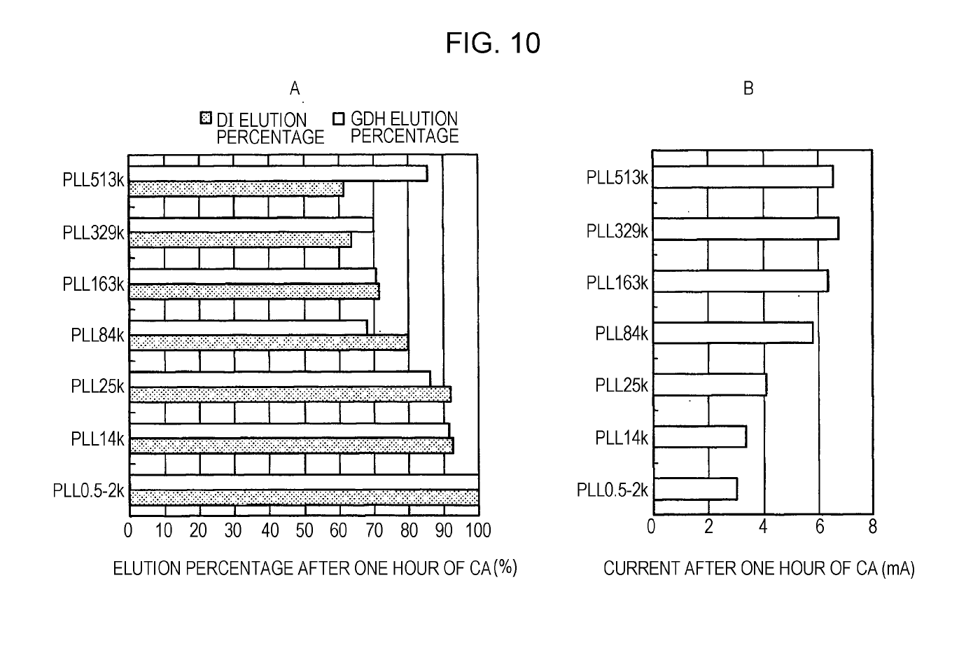

A potential of the thus-prepared enzyme/coenzyme/electron mediator-immobilized electrode was set to 0.1 V, which is a sufficiently higher potential than the oxidation-reduction potential of the electron mediator, and chronoamperometry (CA) was performed on the electrode with respect to a reference electrode Ag|AgCl using a measurement solution. The measurement solution was prepared by dissolving glucose serving as a fuel in a 2.0 M imidazole/hydrochloric acid buffer solution (pH 7.0) (a buffer solution obtained by neutralizing 2.0 M imidazole with hydrochloric acid so as to have pH 7.0) such that the concentration is adjusted to 0.4 M. FIG. 10B shows the measurement results of current after chronoamperometry was performed for one hour (3600 seconds).

As is clear from FIG. 10B, when the viscosity-average molecular weight of PLL is 25 k (25000) or more, a high current density of 4 mA/cm² or higher is achieved even after one hour. Thus, it is understood that a viscosity-average molecular weight of PLL of 25 k (25000) or more can provide high current and its maintenance ratio. As described below, since a viscosity-average molecular weight of 25000 corresponds to a weight-average molecular weight of about 21500, it can be said that a weight-average molecular weight of PLL of 21500 or more can provide high current and its maintenance ratio.

Furthermore, SDS-PAGE was performed on the thus-prepared enzyme/coenzyme/electron mediator-immobilized electrode to analyze the elution percentages of GDH and DI. FIG. 10A shows the results.

As is clear from FIG. 10A, when the viscosity-average molecular weight of PLL is 25 k (25000) or more, the elution of both GDH and DI is suppressed even after one hour, which corresponds to the result shown in FIG. 10B that a high current is achieved when the viscosity-average molecular weight of PLL is 25 k (25000) or more.

Next, the measurement results of the molecular-weight distribution of PLL obtained by gel permeation chromatography (GPC) will be described. From the results, the relationship between viscosity-average molecular weight and weight-average molecular weight of PLL can be obtained.

(a) Creation of a Calibration Curve with Standard Peg and PEO

### Experimental Procedure

Gel permeation chromatography was performed under the following conditions to create a calibration curve with standard polyethylene glycol (PEG) and standard polyethylene oxide (PEO).

| | |
|---|---|
| Column | TSKGel G5000PWXL-CP |
| Eluent | 0.1 M sodium acetate buffer (pH 5.8) |
| Flow rate | 0.5 mL/min |
| Temperature | 25° C. |
| Detection | differential refractive index (RI) |
| Sample volume | 20 μL |
| Sample concentration | 1.0 mg/ml (solvent: water [1% |
| | ethanol]) |
| Sample | |
| Standard PEG: | Fluka 81288 poly(ethylene glycol) |
| | Standard 1000 |
| Standard PEO: | TOSOH Corporation 05773 TSK Standard |
| | poly(ethyleneoxide)SE-2,5,8,15,30,70,150 |

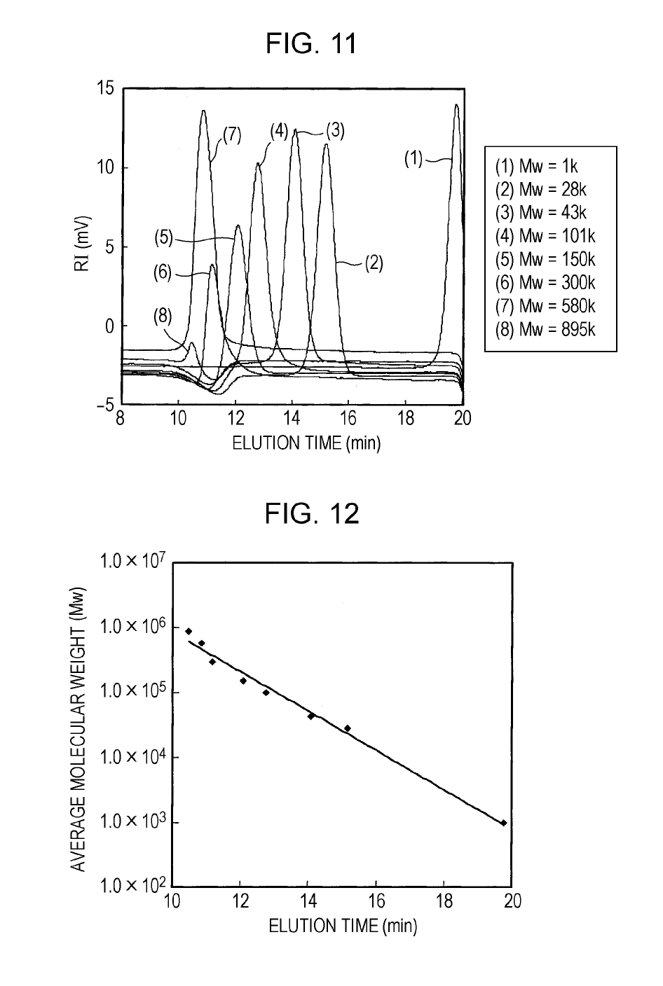

FIG. 11 shows a GPC chart of standard PEG and PEO. Herein, “RI” of the vertical axis of FIG. 11 denotes an output voltage of a differential refractometer.

A calibration curve shown in FIG. 12 was created from the elution time and weight-average molecular weight (Mw) of standard PEG and PEO shown in FIG. 11.

(b) Measurement of Molecular-Weight Distribution of PLL Sample by GPC

Next, the molecular-weight distribution of PLL samples was actually measured.

Experimental Procedure

Gel permeation chromatography was performed under the following conditions to create a calibration curve with standard PEG and standard PEO.

| | |
|---|---|
| Column | TSKGel G5000PWXL-CP |
| Eluent | 0.1 M sodium acetate buffer (pH 5.8) |
| Flow rate | 0.5 mL/min |
| Temperature | 25° C. |
| Detection | RI |
| Sample volume | 20 μL |
| Sample concentration | 1.0 mg/ml (solvent: water) |
| Sample | PLL (produced by Sigma Aldrich |
| | Corporation) named in accordance with |
| | viscosity-average molecular weight |
| PLL 0.5 to 2.0 K | P8954 |
| PLL 14 k | P6516 |
| PLL 25 k | P7890 |
| PLL 84 k | P1274 |
| PLL 163 k | P1399 |
| PLL 329 k | P1524 |
| PLL 513 k | P1524 |

Table 2 shows the data of PLL samples used.

TABLE 2

| | Named in accordance with | |
|---|---|---|
| | viscosity-average molecular weight (Mv) | |
| | | Multi-angle laser light |
| | Viscosity | scattering |
| | Viscosity-average | Weight-average molecular |
| Sample | molecular weight (Mv) | weight (Mw) |
| PLL 0.5 to 2.0 k | 500 to 2000 | 1000 |
| PLL 14 k | 14000 | 8300 |
| PLL 25 k | 25500 | 18800 |
| PLL 84 k | 84000 | 84000 |
| PLL 163 k | 163000 | 101000 |
| PLL 329 k | 329000 | 280000 |
| PLL 513 k | 513000 | 327000 |

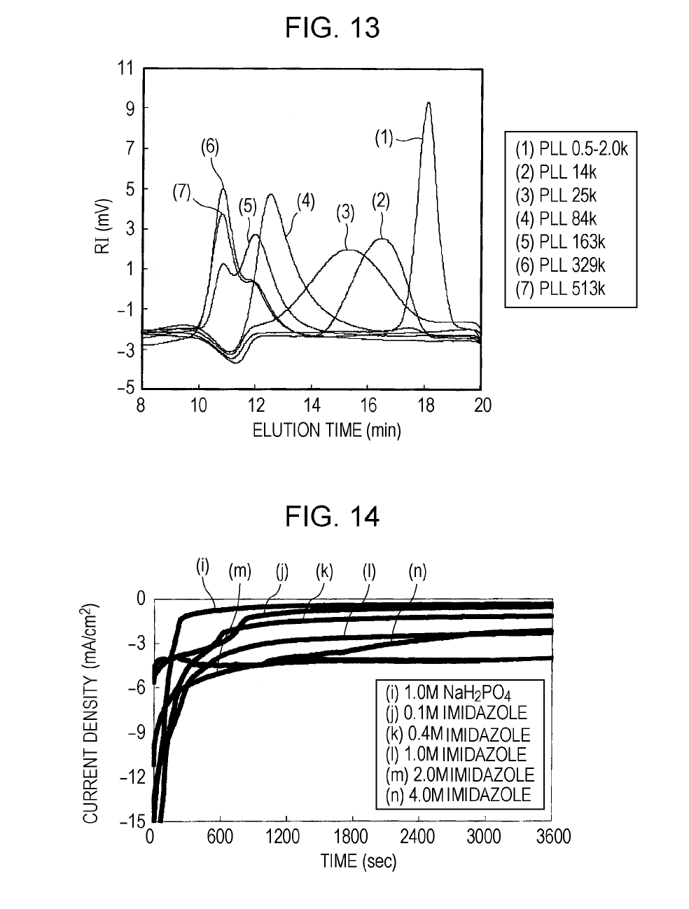

FIG. 13 shows a GPC chart of standard PEG and PEO.

The weight-average molecular weight (Mw) of the PLL samples was calculated from the elution time of the PLL samples shown in FIG. 13 and the calibration curve shown in FIG. 12, and the degree of polymerization of the PLL samples was obtained. Table 3 collectively shows the GPC measurement results of the PLL samples.

TABLE 3

| | Calculated from a | |
|---|---|---|
| | calibration curve of GPC | |
| Elution time (elution peak) | Weight-average molecular | Degree of |
| (min) | weight (Mw) | polymerization |
| 18.1 | 3281 | 16 |
| 16.4 | 10499 | 50 |
| 15.4 | 21581 | 103 |
| 12.5 | 156715 | 750 |
| 12.0 | 226003 | 1081 |
| 10.8 | 500527 | 2395 |
| 10.8 | 507490 | 2428 |

As is clear from Table 3, a viscosity-average molecular weight of PLL of 25 k (25000) corresponds to a weight-average molecular weight of 21581, that is, about 21500, which is equivalent to 103 in terms of degree of polymerization of PLL.

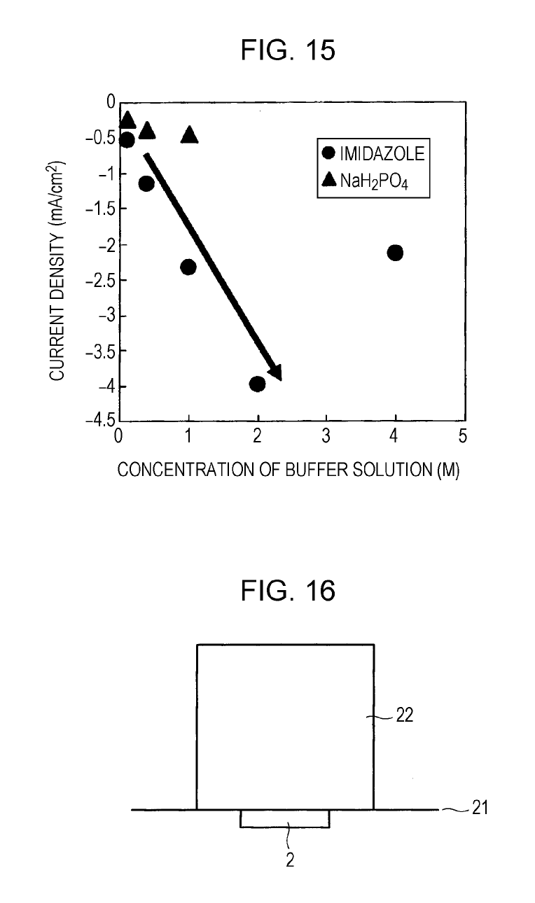

Next, a description will be made of an effect of maintaining and improving a current value in the case where BOD was immobilized on the cathode 2 as an oxygen reductase and a solution prepared by mixing imidazole and hydrochloric acid to adjust the pH to 7 was used as a buffer solution. Table 4 and FIG. 14 show the results of chronoamperometry measured at various concentrations of imidazole under these conditions. In addition, FIG. 15 shows the dependency of the current value (the value of current density after 3600 seconds in Table 4 and FIG. 14) on the concentration of the buffer solution (the concentration of a buffer substance in the buffer solution). For comparison, Table 4 and FIG. 14 also show the results in the case where a 1.0 M NaH₂PO₄/NaOH buffer solution (pH 7) was used as a buffer solution. This measurement was performed in a state in which film-like cellophane 21 was placed on the cathode 2 and a buffer solution 22 was in contact with the cellophane 21, as shown in FIG. 16. Enzyme/electron mediator-immobilized electrodes prepared as described below were used as the cathode 2. First, commercially available carbon felt (produced by TORAY Industries Inc., BO050) was used as porous carbon, and this carbon felt was cut into a one-centimeter square. Next, the carbon felt was sequentially impregnated with 80 μL of hexacyanoferrate ions (100 mM), 80 μL of poly-L-lysine (1 wt %), and 80 μL of a BOD solution (50 mg/mL), and then dried to prepare enzyme/electron mediator-immobilized electrodes. Two enzyme/electron mediator-immobilized electrodes thus prepared were arranged so as to overlap with each other and used as the cathode 2.

TABLE 4

| | Current density (mA/cm²) | | | | | |
|---|---|---|---|---|---|---|
| | 1 sec | 180 sec | 300 sec | 600 sec | 1800 sec | 3600 sec |
| 1.0 M | −17.22 | −3.11 | −1.10 | −0.73 | −0.41 | −0.34 |
| NaH₂PO₄ | | | | | | |
| 0.1 M | −5.64 | −3.98 | −3.71 | −2.98 | −0.70 | −0.54 |
| imidazole | | | | | | |
| 0.4 M | −11.18 | −6.37 | −4.69 | −2.48 | −1.35 | −1.16 |
| imidazole | | | | | | |
| 1.0 M | −15.59 | −8.44 | −5.81 | −3.86 | −2.60 | −2.32 |
| imidazole | | | | | | |
| 2.0 M | −25.10 | −7.39 | −5.88 | −5.01 | −4.20 | −3.99 |
| imidazole | | | | | | |
| 4.0 M | −5.08 | −3.90 | −4.19 | −4.53 | −3.47 | −2.13 |
| imidazole | | | | | | |

As is clear from Table 4 and FIG. 14, when the concentration of NaH₂PO₄ is 1.0 M, the initial current is sufficient, but the current is significantly decreased after 3600 seconds. In contrast, when the concentration of imidazole is 0.4 M, 1.0 M, and 2.0 M, a decrease in current is hardly observed even after 3600 seconds. As is clear from FIG. 15, the current value is linearly increased with respect to concentration in the concentration range of 0.2 to 2.5 M of imidazole. Furthermore, although both a NaH₂PO₄/NaOH buffer solution and an imidazole/hydrochloric acid buffer solution have a pKₐ of about 7 and substantially the same oxygen solubility, in the case where the concentrations of the buffer solutions are the same each other, a larger oxygen-reduction current is obtained in the buffer solution containing imidazole.

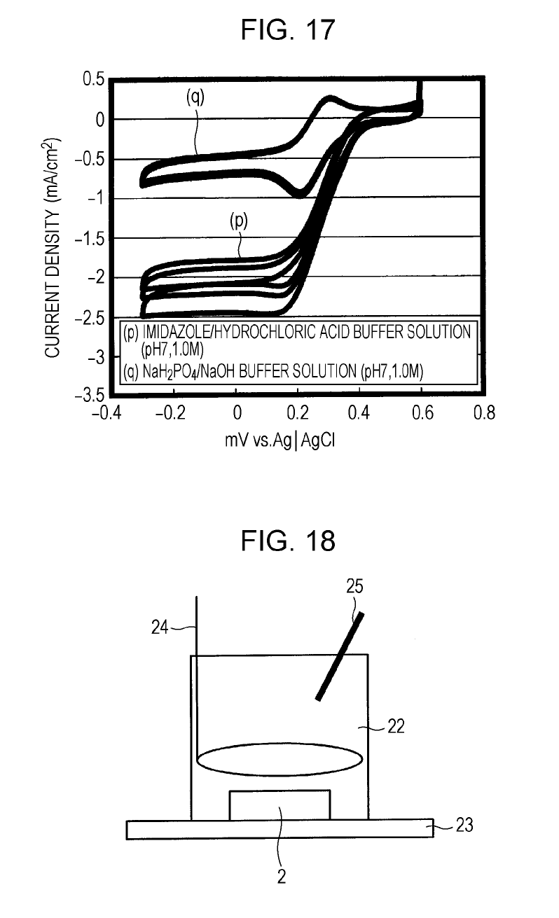

After chronoamperometry was performed for 3600 seconds as described above, cyclic voltammetry (CV) was performed in a potential range of −0.3 to +0.6 V. FIG. 17 shows the results. Note that this measurement was performed in a state in which, as shown in FIG. 18, the cathode 2 composed of the same enzyme/electron mediator-immobilized electrode as that described above was used as a working electrode, this working electrode was placed on an air-permeable PTFE (polytetrafluoroethylene) membrane 23, and a buffer solution 22 was in contact with the cathode 2. A counter electrode 24 and a reference electrode 25 were immersed in the buffer solution 22, and an electrochemical measuring device (not shown) was connected to the cathode 2, which served as a working electrode, the counter electrode 24, and the reference electrode 25. A Pt wire was used as the counter electrode 24, and a Ag|AgCl was used as the reference electrode 25. The measurement was performed at atmospheric pressure, and the measurement temperature was 25° C. Two types of buffer solutions, i.e., an imidazole/hydrochloric acid buffer solution (pH 7, 1.0 M) and a NaH₂PO₄/NaOH buffer solution (pH 7, 1.0 M) were used as the buffer solution 22.

Referring to FIG. 17, it is understood that when the imidazole/hydrochloric acid buffer solution (pH 7, 1.0 M) is used as the buffer solution 22, extremely satisfactory CV characteristics are achieved.

From the above results, it is confirmed that an advantage lies in the imidazole buffer solution even if the system of measurement is changed.

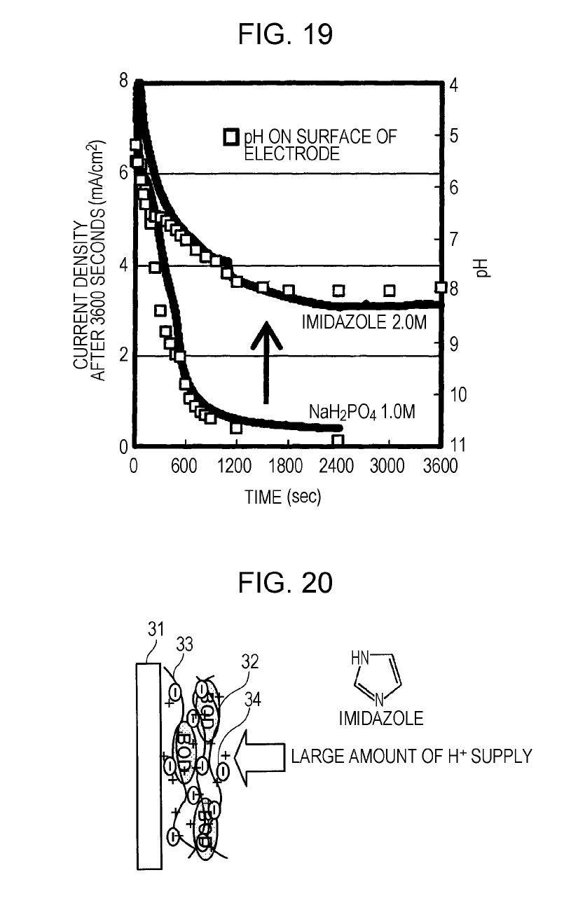

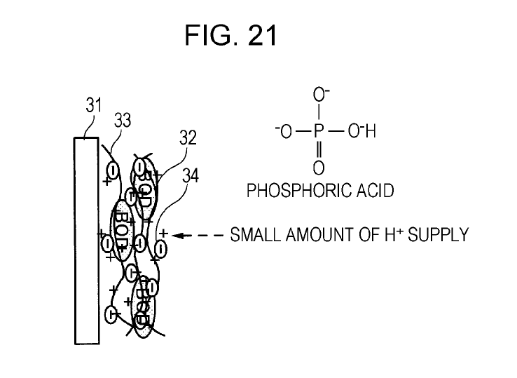

FIG. 19 shows the results of chronoamperometry performed by the same method as that described above in which BOD was immobilized on the cathode 2 and a 2.0 M imidazole/hydrochloric acid buffer solution and a 1.0 M NaH₂PO₄/NaOH buffer solution were used. FIG. 19 also shows the measurement results of pH on the electrode surface obtained during the chronoamperometry. Herein, the pKa of the imidazole/hydrochloric acid buffer solution is 6.95, the electrical conductivity is 52.4 mS/cm, the oxygen solubility is 0.25 mM, and the pH is 7. In addition, the pKa of the NaH₂PO₄/NaOH buffer solution is 6.82 (H₂PO₄⁻), the electrical conductivity is 51.2 mS/cm, the oxygen solubility is 0.25 mM, and the pH is 7. As is clear from FIG. 19, in the case where the 2.0 M imidazole/hydrochloric acid buffer solution is used, a high current density about 15 times higher than that in the case where the 1.0 M NaH₂PO₄/NaOH buffer solution is used is achieved. Furthermore, referring to FIG. 19, it is found that the change in current substantially corresponds to the change in pH on the electrode surface. The reasons why these results are obtained will be described with reference to FIGS. 20 and 21.

FIGS. 20 and 21 each show a state in which BOD 32 is immobilized on an electrode 31 together with an electron mediator 34 using an immobilizing material 33 such as a polyion complex. As shown in FIG. 20, it is believed that when a 2.0 M imidazole/hydrochloric acid buffer solution is used, a sufficiently large amount of protons (H⁺) is supplied, whereby a high buffering capacity is achieved and the pH is stabilized, and thus a high current density is constantly obtained. In contrast, as shown in FIG. 21, it is believed that when a 1.0 M NaH₂PO₄/NaOH buffer solution is used, the amount of H⁺ supplied is small, whereby the buffering capacity becomes insufficient and the pH is significantly increased, and thus the current density is decreased.

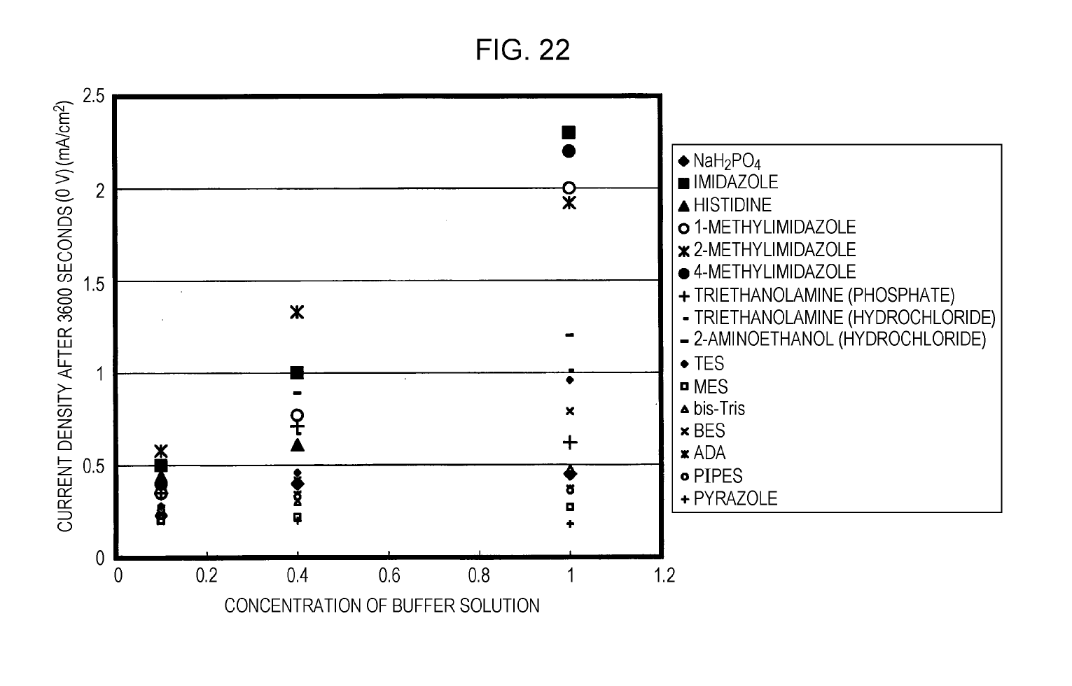

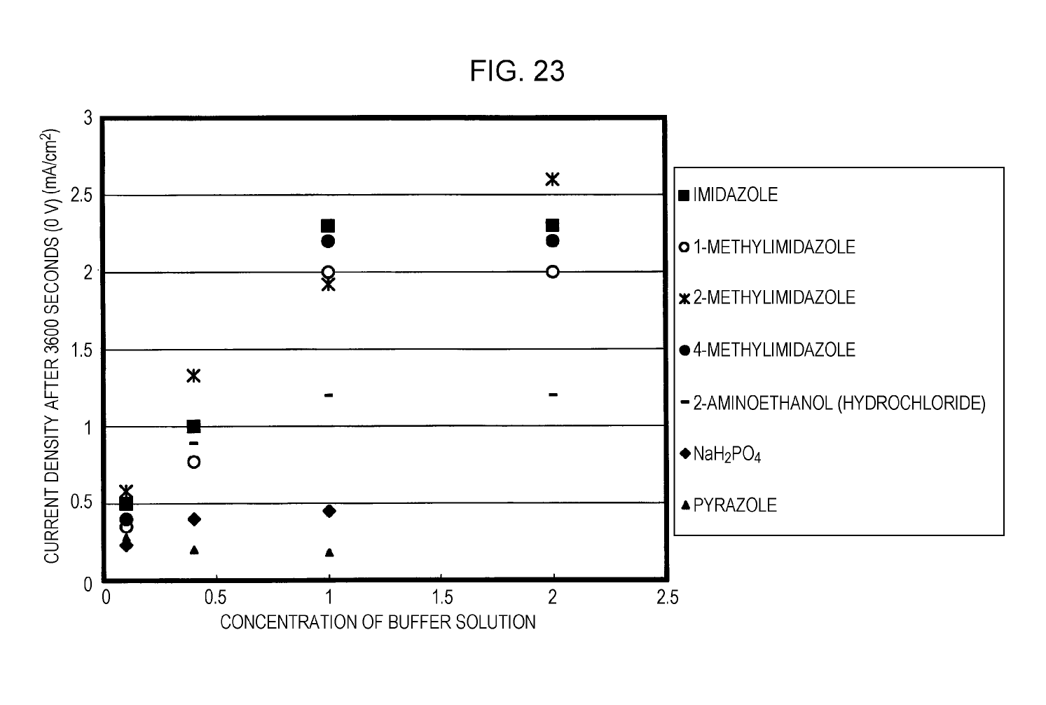

FIGS. 22 and 23 each show a change in current density after 3600 seconds (one hour) as a function of the concentration of a buffer solution when various buffer solutions were used. As is clear from FIGS. 22 and 23, in the cases where buffer solutions each containing a compound having an imidazole ring are used, high current densities are achieved on the whole, compared with the cases where other buffer solutions such as a buffer solution containing NaH₂PO₄ are used. In particular, this tendency becomes significant as the concentration of the buffer solution is increased. Furthermore, referring to FIGS. 22 and 23, it is also found that, in the cases where a buffer solution containing 2-aminoethanol, triethanolamine, TES, or BES used as a buffer substance is used, high current densities are achieved, and this tendency becomes particularly significant as the concentration of the buffer solution is increased.

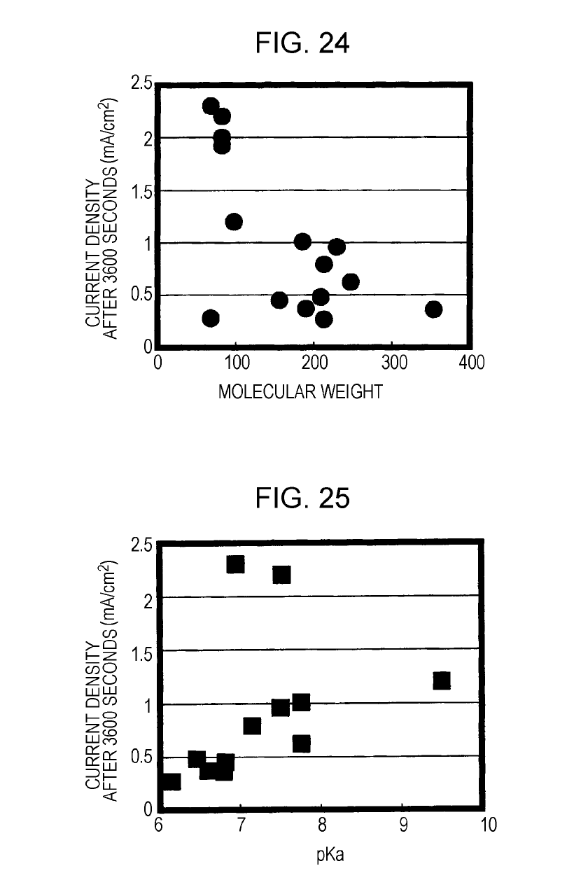

FIGS. 24 and 25 are plots of the current densities after 3600 seconds as a function of the molecular weight of a buffer substance and pKₐ, respectively, when the buffer solutions shown in FIGS. 22 and 23 were used.

Next, the activities of BOD when the buffer solutions below were used were compared with each other. An example of the experimental results will be described.
2.0 M imidazole/hydrochloric acid aqueous solution (a solution obtained by neutralizing 2.0 M imidazole with hydrochloric acid so as to have pH 7.0) (2.0 M imidazole/hydrochloric acid buffer solution)
2.0 M imidazole/acetic acid aqueous solution (a solution obtained by neutralizing 2.0 M imidazole with acetic acid so as to have pH 7.0) (2.0 M imidazole/acetic acid buffer solution)
2.0 M imidazole/phosphoric acid aqueous solution (a solution obtained by neutralizing 2.0 M imidazole with phosphoric acid so as to have pH 7.0) (2.0 M imidazole/phosphoric acid buffer solution)
2.0 M imidazole/sulfuric acid aqueous solution (a solution obtained by neutralizing 2.0 M imidazole with sulfuric acid so as to have pH 7.0) (2.0 M imidazole/sulfuric acid buffer solution)

The activity of BOD was measured by monitoring a change in the absorbance of light having a wavelength of 730 nm, the change being caused by the progress of a reaction (caused by an increase in the amount of reactant of ABTS), using ABTS (2,2′-azino-bis(3-ethylbenzothiazoline-6-sulfonic acid)diammonium salt) as a substrate. Table 5 shows the measurement conditions. Herein, the BOD concentration was controlled so that the change in the absorbance of light having a wavelength of 730 nm was adjusted to about 0.01 to 0.2 per minute when the activity was measured. The reaction was initiated by adding an enzyme solution (5 to 20 μL) to various buffer solutions (2980 to 2995 μL) shown in Table 5 and containing ABTS.

TABLE 5

| | |
|---|---|
| Buffer solution | 2.0 M imidazole/hydrochloric acid aqueous solution |
| | (pH 7.0) |
| | 2.0 M imidazole/acetic acid aqueous solution (pH 7.0) |
| | 2.0 M imidazole/phosphoric acid aqueous solution |
| | (pH 7.0) |
| | 2.0 M imidazole/sulfuric acid aqueous solution (pH 7.0) |
| ABTS | 2 mM (final concentration) |
| concentration | |
| O₂ | Air saturation (210 μM; 25° C.) |
| concentration | |
| Reaction | 25° C. |
| temperature | |

Table 6 shows the measurement results of enzyme activity as a relative activity value when the activity value in the 2.0 M imidazole/hydrochloric acid aqueous solution (pH 7.0) is assumed to be 1.0.

TABLE 6

| | Relative |
|---|---|
| | activity |
| Type of buffer solution | value |
| 2.0 M imidazole/hydrochloric acid aqueous solution (pH 7.0) | 1.0 |
| 2.0 M imidazole/acetic acid aqueous solution (pH 7.0) | 2.1 |
| 2.0 M imidazole/phosphoric acid aqueous solution (pH 7.0) | 3.7 |
| 2.0 M imidazole/sulfuric acid aqueous solution (pH 7.0) | 11.2 |

As is apparent from Table 6, in the case where the imidazole/acetic acid aqueous solution, the imidazole/phosphoric acid aqueous solution, and the imidazole/sulfuric acid aqueous solution are used, the enzyme activity is higher than that in the case where the imidazole/hydrochloric acid aqueous solution is used. In particular, the enzyme activity in the case where the imidazole/sulfuric acid aqueous solution is used is markedly high.

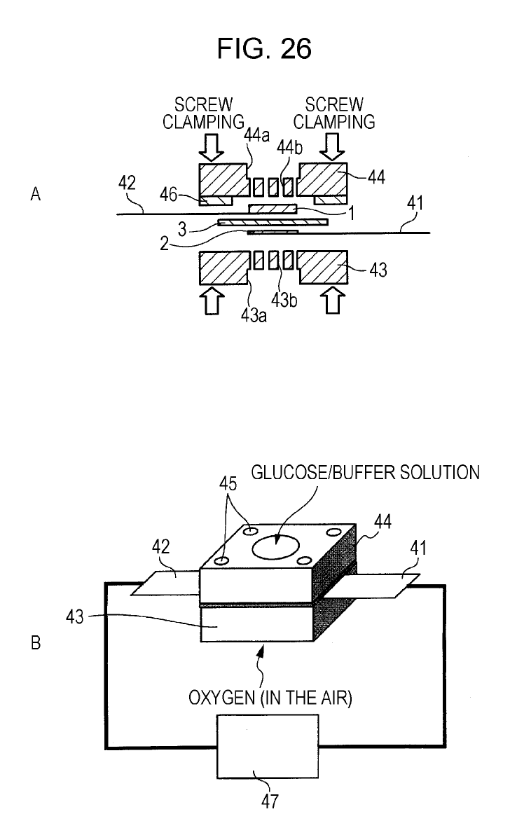

FIGS. 26A and 26B show the specific configuration example of the biofuel cell.

As shown in FIGS. 26A and 26B, this biofuel cell has a structure in which an anode 1 and a cathode 2 face each other with an electrolyte layer 3 therebetween, the electrolyte layer 3 containing a buffer substance. The anode 1 is obtained by immobilizing an enzyme, a coenzyme, and an electron mediator on a carbon electrode as described above. The cathode 2 is obtained by immobilizing an enzyme and an electron mediator on a carbon electrode as described above. In this case, Ti current collectors 41 and 42 are respectively placed on the bottom of the cathode 2 and the top of the anode 1 so as to easily perform current collection. Reference numerals 43 and 44 each denote a clamping plate. The clamping plates 43 and 44 are connected to each other with screws 45 so as to sandwich all of the cathode 2, the anode 1, the electrolyte layer 3, and the Ti current collectors 41 and 42. A circular depressed portion 43a for taking in air is formed in one surface (outer surface) of the clamping plate 43, and many holes 43b that extend to the other surface are formed in the bottom surface of the depressed portion 43a. These holes 43b are supply routes of air to the cathode 2. On the other hand, a circular depressed portion 44a for supplying a fuel is formed in one surface (outer surface) of the clamping plate 44, and many holes 44b that extend to the other surface are formed in the bottom surface of the depressed portion 44a. These holes 44b are supply routes of a fuel to the anode 1. A spacer 46 is disposed on the periphery of the other surface of the clamping plate 44 so that a certain space is formed when the clamping plates 43 and 44 are connected to each other with the screws 45.

As shown in FIG. 26B, a load 47 is disposed between the Ti current collectors 41 and 42, and a glucose solution prepared by, for example, dissolving glucose in a phosphoric acid buffer solution is inserted, as a fuel, into the depressed portion 44a of the clamping plate 44 to perform power generation.

As described above, according to the first embodiment, when glucose dehydrogenase and diaphorase are immobilized on the anode 1 using an immobilizing material composed of poly-L-lysine and glutaraldehyde, the mass ratio thereof and the average molecular weight of poly-L-lysine are optimized. Specifically, the mass ratio of poly-L-lysine to glutaraldehyde is set to 5:1 to 80:1. Furthermore, the average molecular weight of poly-L-lysine is set to 21500 or more. Moreover, the mass ratio of glucose dehydrogenase to diaphorase is set to 1:3 to 200:1. Thus, a high-performance biofuel cell having a high current density and its maintenance ratio can be achieved. Such a biofuel cell is suitably applied to the power sources of various electronic apparatuses, mobile units, and power generation systems.

### 2. Second Embodiment

### [Biofuel Cell]

Next, a biofuel cell according to a second embodiment of the present invention will be described.

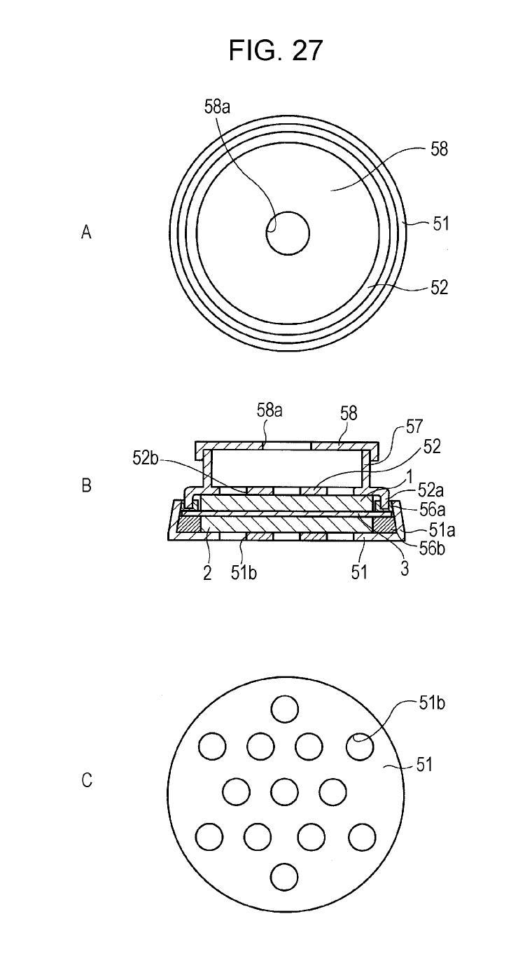

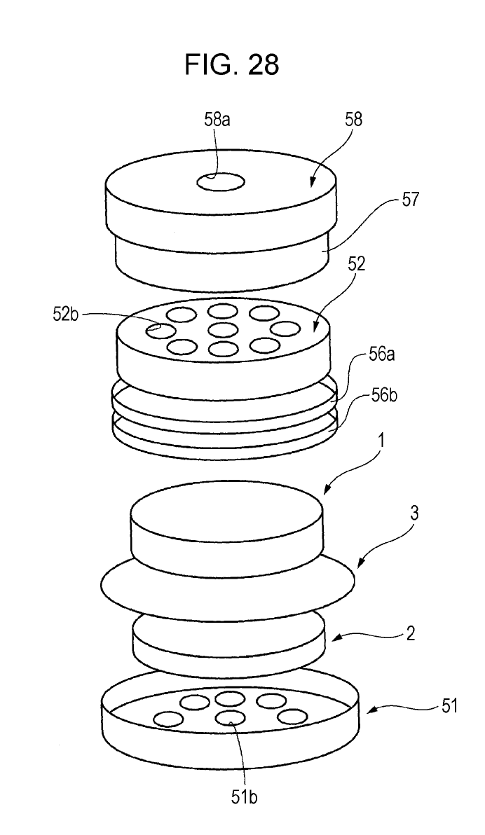

FIGS. 27A, 27B, 27C, and 28 show the biofuel cell. FIGS. 27A, 27B, and 27C are a top view, a sectional view, and a bottom view of the biofuel cell, respectively. FIG. 28 is an exploded perspective view showing exploded individual components of the biofuel cell.

As shown in FIGS. 27A, 27B, 27C, and 28, in this biofuel cell, a cathode 2, an electrolyte layer 3, and an anode 1 are accommodated inside a space formed between a cathode current collector 51 and an anode current collector 52. The cathode 2, the electrolyte layer 3, and the anode 1 are sandwiched between the cathode current collector 51 and the anode current collector 52 in a vertical direction. Among the cathode current collector 51, the anode current collector 52, the cathode 2, the electrolyte layer 3, and the anode 1, adjacent components are in close contact with each other. In this case, the cathode current collector 51, the anode current collector 52, the cathode 2, the electrolyte layer 3, and the anode 1 each have a circular planar shape, and the biofuel cell also has a circular planer shape as a whole.

The cathode current collector 51 is configured to collect a current generated at the cathode 2, and the current is transferred from the cathode current collector 51 to the outside. In addition, the anode current collector 52 is configured to collect a current generated at the anode 1. The cathode current collector 51 and the anode current collector 52 are generally composed of a metal or an alloy, but the material is not limited to this. The cathode current collector 51 is flat and has a substantially cylindrical shape. The anode current collector 52 is also flat and has a substantially cylindrical shape. Furthermore, the edge of an outer peripheral portion 51a of the cathode current collector 51 is caulked to an outer peripheral portion 52a of the anode current collector 52 with a ring-shaped gasket 56a and a ring-shaped hydrophobic resin 56b therebetween, thereby forming a space in which the cathode 2, the electrolyte layer 3, and the anode 1 are accommodated. The gasket 56a is composed of an insulating material such as silicone rubber. Furthermore, the hydrophobic resin 56b is composed of, for example, polytetrafluoroethylene (PTFE). The hydrophobic resin 56b is disposed in the space surrounded by the cathode 2, the cathode current collector 51, and the gasket 56a so as to be in close contact with the cathode 2, the cathode current collector 51, and the gasket 56a. The hydrophobic resin 56b can effectively suppress excessive impregnation of a fuel to the cathode 2 side. The end of the electrolyte layer 3 extends outward from the cathode 2 and the anode 1 so as to be sandwiched between the gasket 56a and the hydrophobic resin 56b. The cathode current collector 51 has a plurality of oxidizing agent supply ports 51b formed in the entire surface of the bottom face thereof, and the cathode 2 is exposed in the oxidizing agent supply ports 51b. FIGS. 27C and 28 show thirteen circular oxidizing agent supply ports 51b, but this is a mere example, and the number, the shape, the size, and the arrangement of oxidizing agent supply ports 51b may be suitably selected. The anode current collector 52 also has a plurality of fuel supply ports 52b formed in the entire surface of the top face thereof, and the anode 1 is exposed in the fuel supply ports 52b. FIG. 28 shows nine circular fuel supply ports 52b, but this is a mere example, and the number, the shape, the size, and the arrangement of fuel supply ports 52b may be suitably selected.

The anode current collector 52 has a cylindrical fuel tank 57 disposed on a surface opposite the anode 1. The fuel tank 57 is formed integrally with the anode current collector 52. A fuel to be used (not shown), for example, a glucose solution, a glucose solution further containing an electrolyte, or the like is charged into the fuel tank 57. A cylindrical cover 58 is removably attached to the fuel tank 57. The cover 58 is, for example, fitted into or screwed on the fuel tank 57. A circular fuel supply port 58a is formed in the center of the cover 58. The fuel supply port 58a is sealed by, for example, attaching a hermetic seal that is not shown in the drawing.

The configuration of this biofuel cell other than the above-described configuration is the same as that of the first embodiment as long as the nature thereof is not impaired.

[Method for Manufacturing Biofuel Cell]

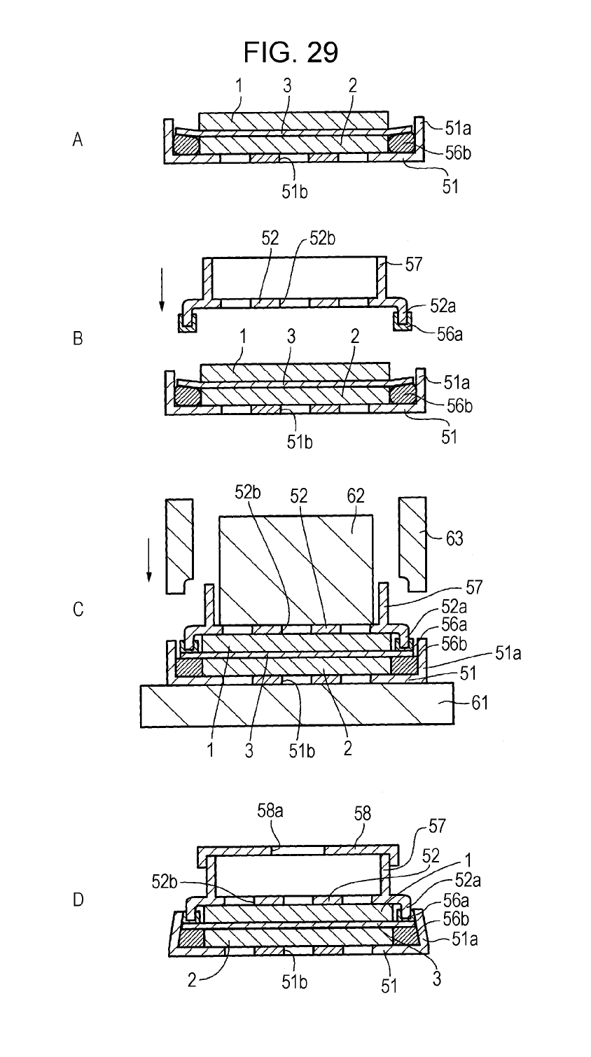

Next, an example of a method for manufacturing the biofuel cell will be described. FIGS. 29A to 29D show the manufacturing method.

As shown in FIG. 29A, first, a cathode current collector 51 having a cylindrical shape with an open end is prepared. The cathode current collector 51 has a plurality of oxidizing agent supply ports 51b formed in the entire surface of the bottom face thereof. A ring-shaped hydrophobic resin 56b is placed on the outer peripheral portion of the inner bottom face of the cathode current collector 51, and a cathode 2, an electrolyte layer 3, and an anode 1 are sequentially stacked on the central portion of the bottom face.

Meanwhile, as shown in FIG. 29B, an anode current collector 52 having a cylindrical shape with an open end and a fuel tank 57 formed integrally with the anode current collector 52 are prepared. The anode current collector 52 has a plurality of fuel supply ports 52b formed in the entire surface thereof. A gasket 56a having a U-shaped section is attached to the edge of the peripheral surface of the anode current collector 52. Furthermore, the anode current collector 52 is placed on the anode 1 so that the open end faces downward, and the cathode 2, the electrolyte layer 3, and the anode 1 are sandwiched between the cathode current collector 51 and the anode current collector 52.

Next, as shown in FIG. 29C, the cathode current collector 51 and the anode current collector 52 with the cathode 2, the electrolyte layer 3, and the anode 1 sandwiched therebetween are placed on a base 61 of a caulking machine, and the anode current collector 52 is pressed with a pressing member 62 to bring the cathode current collector 51, the cathode 2, the electrolyte layer 3, the anode 1, and the anode current collector 52 into close contact with each other. In this state, a caulking tool 63 is moved downward to caulk the edge of an outer peripheral portion 51a of the cathode current collector 51 to an outer peripheral portion 52a of the anode current collector 52 with the gasket 56a and the hydrophobic resin 56b therebetween. This caulking is performed such that the gasket 56a is gradually crushed so as not to form a gap between the cathode current collector 51 and the gasket 56a and between the anode current collector 52 and the gasket 56a. Furthermore, in this case, the hydrophobic resin 56b is also gradually compressed so as to be brought into close contact with the cathode 2, the cathode current collector 51, and the gasket 56a. Consequently, a space for accommodating the cathode 2, the electrolyte layer 3, and the anode 1 is formed inside the cathode current collector 51 and the anode current collector 52 while the cathode current collector 51 and the anode current collector 52 are electrically insulated from each other due to the gasket 56a. The caulking tool 63 is then moved upward.

Thus, as shown in FIG. 29D, the biofuel cell is manufactured, in which the cathode 2, the electrolyte layer 3, and the anode 1 are accommodated in the space formed between the cathode current collector 51 and the anode current collector 52.

Next, a cover 58 is attached to the fuel tank 57, and a fuel and an electrolyte are injected through a fuel supply port 58a of the cover 58. The fuel supply port 58a is then closed by, for example, attaching a hermetic seal. However, the fuel and electrolyte may be injected into the fuel tank 57 in the step shown in FIG. 29B.

In the biofuel cell, for example, when a glucose solution is used as the fuel to be charged into the fuel tank 57, at the anode 1, the supplied glucose is decomposed with an enzyme to produce electrons and to generate H⁺. At the cathode 2, water is produced from H⁺ transported from the anode 1 through the electrolyte layer 3, the electrons transferred from the anode 1 through an external circuit, and oxygen in the air, for example. As a result, an output voltage is generated between the cathode current collector 51 and the anode current collector 52.

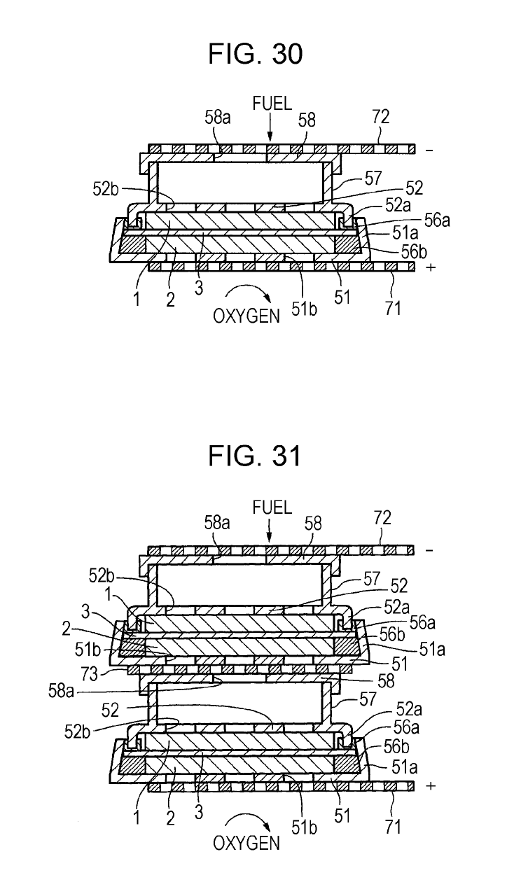

As shown in FIG. 30, mesh electrodes 71 and 72 may be formed on the cathode current collector 51 and the anode current collector 52 of this biofuel cell, respectively. In this case, outside air enters the oxidizing agent supply ports 51b of the cathode current collector 51 through holes of the mesh electrode 71, and a fuel enters the fuel tank 57 from the fuel supply port 58a of the cover 58 through holes of the mesh electrode 72.

FIG. 31 shows a case in which two biofuel cells are connected to each other in series. In this case, a mesh electrode 73 is sandwiched between the cathode current collector 51 of one of the biofuel cells (in the drawing, the upper biofuel cell) and the cover 58 of the other of the biofuel cells (in the drawing, the lower biofuel cell). Furthermore, in this case, outside air enters the oxidizing agent supply ports 51b of the cathode current collector 51 through holes of the mesh electrode 73. A fuel can also be supplied using a fuel supply system.

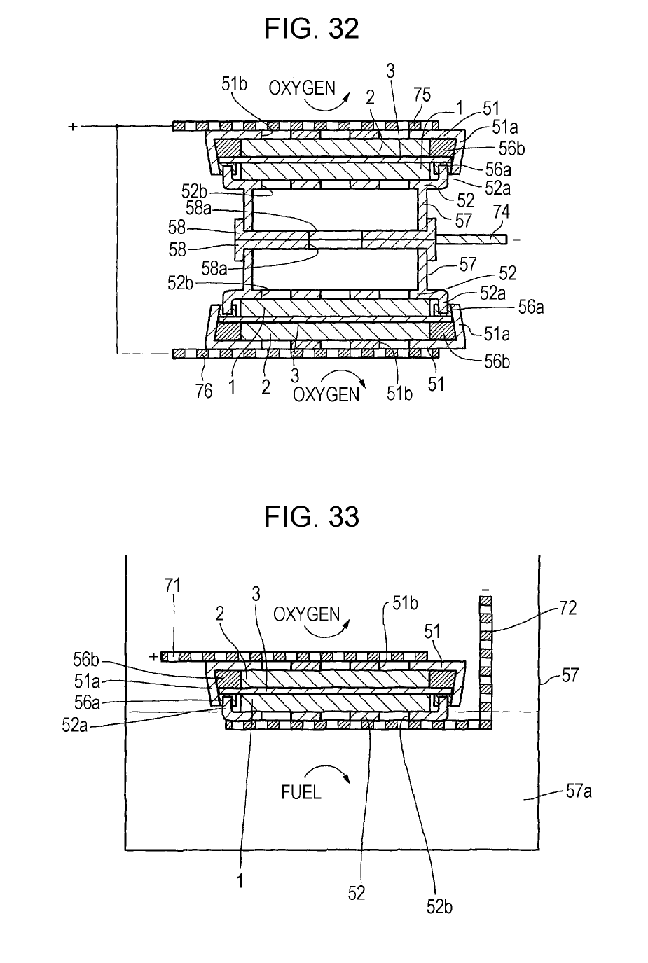

FIG. 32 shows a case in which two biofuel cells are connected in parallel. In this case, the fuel tank 57 of one of the biofuel cells (in the drawing, the upper biofuel cell) and the fuel tank 57 of the other of the biofuel cells (in the drawing, the lower biofuel cell) are brought into contact with each other so that the fuel supply ports 58a of the covers 58 coincide with each other, and an electrode 74 is drawn from the side faces of these fuel tanks 57. In addition, mesh electrodes 75 and 76 are formed on the cathode current collector 51 of one of the biofuel cells and the cathode current collector 51 of the other of the biofuel cells, respectively. These mesh electrodes 75 and 76 are connected to each other. Outside air enters the oxidizing agent supply ports 51b of the cathode current collectors 51 through holes of the mesh electrodes 75 and 76.

According to the second embodiment, the same advantages as those of the first embodiment can be achieved in the coin-type or button-type biofuel cell excluding the fuel tank 57. Furthermore, in this biofuel cell, the cathode 2, the electrolyte layer 3, and the anode 1 are sandwiched between the cathode current collector 51 and the anode current collector 52, and the edge of the outer peripheral portion 51a of the cathode current collector 51 is caulked to the outer peripheral portion 52a of the anode current collector 52 with the gasket 56a therebetween. Accordingly, the individual components can be uniformly brought into close contact with each other, whereby a variation in output can be prevented and the leakage of cell solutions such as the fuel and the electrolyte from the interfaces between the individual components can also be prevented. In addition, this biofuel cell is manufactured in a simple manufacturing process. Moreover, this biofuel cell is easily reduced in size. Furthermore, in this biofuel cell, a glucose solution or starch is used as a fuel, and about pH 7 (neutrality) is selected as the pH of the electrolyte used. Accordingly, the biofuel cell is safe even if the fuel or the electrolyte leaks to the outside.

Furthermore, in air cells that are currently put into practical use, a fuel and an electrolyte needs to be added during the manufacturing, and thus it is difficult to add a fuel and an electrolyte after the manufacturing. In contrast, in this biofuel cell, since a fuel and an electrolyte can be added after the manufacturing, the biofuel cell can be manufactured more easily than the air cells that are currently put into practical use.

### 3. Third Embodiment

### [Biofuel Cell]

Next, a biofuel cell according to a third embodiment of the present invention will be described.

As shown in FIG. 33, in the third embodiment, the fuel tank 57 provided integrally with the anode current collector 52 is removed from the biofuel cell according to the second embodiment. In addition, the mesh electrodes 71 and 72 are disposed on the cathode current collector 51 and the anode current collector 52, respectively. The biofuel cell is used in a state in which the biofuel cell floats on a fuel 57a charged in an open fuel tank 57 so that the anode 1 faces downward and the cathode 2 faces upward.

The configuration of the third embodiment other than the above-described configuration is the same as those of the first and second embodiments as long as the nature thereof is not impaired.

According to the third embodiment, the same advantages as those of the first and second embodiments can be achieved.

### 4. Fourth Embodiment

### [Biofuel Cell]

Next, a biofuel cell according to a fourth embodiment of the present invention will be described. The biofuel cell according to the second embodiment is a coin type or a button type whereas this biofuel cell is a cylindrical type.

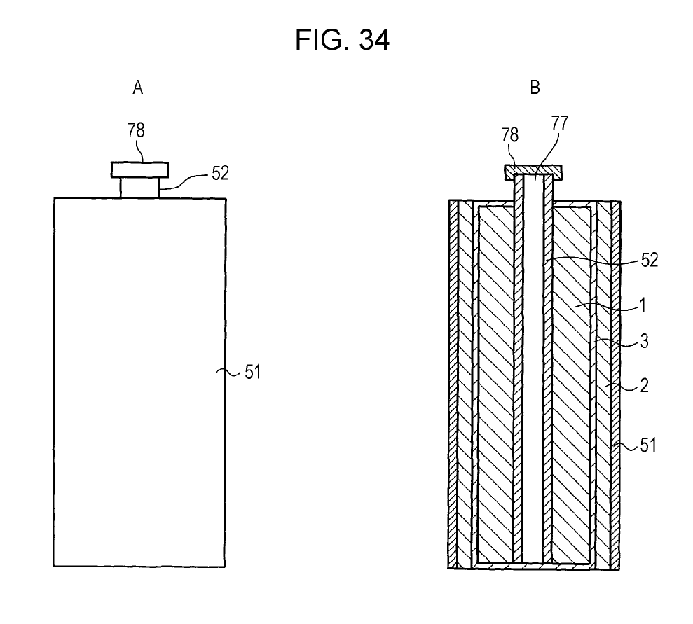

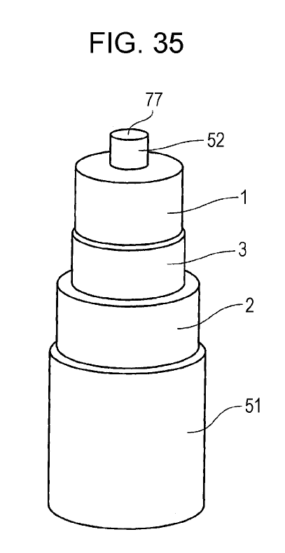

FIGS. 34A, 34B, and 35 show the biofuel cell. FIG. 34A is a front view of the biofuel cell, FIG. 34B is a longitudinal sectional view of the biofuel cell, and FIG. 35 is an exploded perspective view showing exploded individual components of the biofuel cell.

As shown in FIGS. 34A, 34B, and 35, in the biofuel cell, an anode current collector 52, an anode 1, an electrolyte layer 3, a cathode 2, and a cathode current collector 51, each of which has a cylindrical shape, are sequentially disposed on the outer periphery of a columnar fuel storage portion 77. In this case, the fuel storage portion 77 includes a space surrounded by the cylindrical anode current collector 52. One end of the fuel storage portion 77 projects outward, and a cover 78 is disposed on the one end. Although not shown in the drawings, a plurality of fuel supply ports 52b are formed in the entire surface of the anode current collector 52 disposed on the outer periphery of the fuel storage portion 77. In addition, the electrolyte layer 3 has a bag shape that wraps the anode 1 and the anode current collector 52. The portion between the electrolyte layer 3 and the anode current collector 52 at an end of the fuel storage portion 77 is sealed with, for example, a sealing member (not shown) so that a fuel does not leak from this portion.

In this biofuel cell, a fuel and an electrolyte are charged into the fuel storage portion 77. The fuel and the electrolyte pass through the fuel supply ports 52b of the anode current collector 52, reach the anode 1, and infiltrate into pore portions of the anode 1, whereby the fuel and the electrolyte are stored in the anode 1. To increase the amount of fuel that can be stored in the anode 1, the porosity of the anode 1 is desirably, for example, 60% or more, but is not limited to this.

In this biofuel cell, a gas-liquid separation layer may be formed on the outer peripheral surface of the cathode current collector 51 to improve durability. As the material for the gas-liquid separation layer, for example, a waterproof moisture-permeable material (a composite material of a stretched polytetrafluoroethylene film and a polyurethane polymer) (e.g., Gore-Tex (trade name) produced by W.L. Gore & Associates, Inc.) may be used. To uniformly bring the individual components of the biofuel cell into close contact with each other, preferably, stretchable rubber (which may have a band-like or sheet-like shape) having a network structure through which air can pass from the outside is wound outside or inside the gas-liquid separation layer so that the whole components of the biofuel cell are fastened.

The configuration of the fourth embodiment other than the above-described configuration is the same as those of the first and second embodiments as long as the nature thereof is not impaired.

According to the fourth embodiment, the same advantages as those of the first and second embodiments can be achieved.

The embodiments of the present invention have been specifically described above, but the present invention is not limited to the embodiments described above and various modifications can be made on the basis of the technical idea of the present invention.

For example, the numerical values, structures, configurations, shapes, materials, and the like described in the above embodiments are mere examples, and other numerical values, structures, configurations, shapes, materials, and the like, all of which are different from the above, may be optionally used.

1. A fuel cell comprising a structure in which a cathode and an anode face each other with a proton conductor therebetween,
wherein the anode is obtained by immobilizing at least glucose dehydrogenase and diaphorase on an electrode using an immobilizing material composed of poly-L-lysine and glutaraldehyde, and
the mass ratio of the poly-L-lysine to the glutaraldehyde is 5:1 to 80:1.

2. The fuel cell according to claim 1, wherein the electrode is composed of carbon.

3. The fuel cell according to claim 2, wherein the carbon is porous carbon.

4. The fuel cell according to claim 3, wherein the proton conductor is composed of an electrolyte containing a compound having an imidazole ring as a buffer substance.

5. The fuel cell according to claim 4, wherein at least one acid selected from the group consisting of hydrochloric acid, acetic acid, phosphoric acid, and sulfuric acid is added to the compound having an imidazole ring.

6. A method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the mass ratio of the poly-L-lysine to the glutaraldehyde is set to 5:1 to 80:1.

7. An electronic apparatus comprising:
one or more fuel cells,
wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the mass ratio of the poly-L-lysine to the glutaraldehyde is 5:1 to 80:1.

8. An enzyme-immobilized electrode,
wherein at least glucose dehydrogenase and diaphorase are immobilized on an electrode using an immobilizing material composed of poly-L-lysine and glutaraldehyde, and
the mass ratio of the poly-L-lysine to the glutaraldehyde is 5:1 to 80:1.

9. A method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the mass ratio of the poly-L-lysine to the glutaraldehyde is set to 5:1 to 80:1.

10. A fuel cell comprising a structure in which a cathode and an anode face each other with a proton conductor therebetween,
wherein the anode is obtained by immobilizing at least glucose dehydrogenase and diaphorase on an electrode using an immobilizing material composed of poly-L-lysine and glutaraldehyde, and
the average molecular weight of the poly-L-lysine is 21500 or more.

11. A method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the average molecular weight of the poly-L-lysine is set to 21500 or more.

12. An electronic apparatus comprising:
one or more fuel cells,
wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the average molecular weight of the poly-L-lysine is 21500 or more.

13. An enzyme-immobilized electrode,
wherein at least glucose dehydrogenase and diaphorase are immobilized on an electrode using an immobilizing material composed of poly-L-lysine and glutaraldehyde, and
the average molecular weight of the poly-L-lysine is 21500 or more.

14. A method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the average molecular weight of the poly-L-lysine is set to 21500 or more.

15. A fuel cell comprising a structure in which a cathode and an anode face each other with a proton conductor therebetween,
wherein the anode is obtained by immobilizing at least glucose dehydrogenase and diaphorase on an electrode using an immobilizing material composed of poly-L-lysine and glutaraldehyde, and
the mass ratio of the glucose dehydrogenase to the diaphorase is 1:3 to 200:1.

16. A method for manufacturing a fuel cell, wherein when a fuel cell having a structure in which a cathode and an anode face each other with a proton conductor therebetween, the anode being obtained by immobilizing at least glucose dehydrogenase and diaphorase on an electrode using an immobilizing material composed of poly-L-lysine and glutaraldehyde, is manufactured, the mass ratio of the glucose dehydrogenase to the diaphorase is set to 1:3 to 200:1.

17. An electronic apparatus comprising:
one or more fuel cells,
wherein at least one of the fuel cells has a structure in which a cathode and an anode face each other with a proton conductor therebetween; the anode is obtained by immobilizing at least glucose dehydrogenase and diaphorase on an electrode using an immobilizing material composed of poly-L-lysine and glutaraldehyde; and the mass ratio of the glucose dehydrogenase to the diaphorase is 1:3 to 200:1.

18. An enzyme-immobilized electrode,
wherein at least glucose dehydrogenase and diaphorase are immobilized on an electrode using an immobilizing material composed of poly-L-lysine and glutaraldehyde, and
the mass ratio of the glucose dehydrogenase to the diaphorase is 1:3 to 200:1.

19. A method for manufacturing an enzyme-immobilized electrode, wherein when an enzyme-immobilized electrode including at least glucose dehydrogenase and diaphorase immobilized on an electrode using an immobilizing material composed of poly-L-lysine and glutaraldehyde is manufactured, the mass ratio of the glucose dehydrogenase to the diaphorase is set to 1:3 to 200:1.
